(19) United States
(12) Patent Application Publication
(10) Pub. No.: US 2014/0088252 A1
(43) Pub. Date: Mar. 27, 2014

(54) METHOD FOR MAKING SPECIFIC PRODUCTS FROM POLYSACCHARIDE MOLECULE

(71) Applicants: Ali Harlin, Vtt (FI); Harri Setälä, Vtt (FI); Helinä Talja, Vtt (FI)

(72) Inventors: Ali Harlin, Vtt (FI); Harri Setälä, Vtt (FI); Helinä Talja, Vtt (FI)

(73) Assignee: Teknologian Tutkimuskeskus Vtt, Vtt (FI)

(21) Appl. No.: 14/006,797

(22) PCT Filed: Mar. 22, 2012
(86) PCT No.: PCT/FI2012/050291

§ 371 Date: Nov. 29, 2013

(30) Foreign Application Priority Data
Mar. 22, 2011 (FI) 20115279
Aug. 29, 2011 (FI) 20115841

(51) Int. Cl. C08F 8/00; C08B 15/00; C08B 37/00

(52) U.S. Cl. CPC C08F 8/00; C08B 37/00; C08B 15/005
USPC 525/54.23; 536/123; 536/56; 536/57

(57) ABSTRACT

A method for preparing a specific product from a polysaccharide in which at least one hydroxyl of a saccharide unit is substituted with an ether or ester moiety. The ether or ester moiety is provided with ethenyl and/or epoxy functionality for preparing an activatable polysaccharide polymer and the activatable polysaccharide polymer with ethenyl and/or epoxy functionality is optionally reacted with an additional coupling reagent, having at least two coupling functionality for preparing polysaccharide polymer with additional activatable crosslinker. Thereafter, the activatable polysaccharide polymer or the polysaccharide polymer with an additional activatable crosslinker, is activated for crosslinking the polysaccharide polymer with another polysaccharide polymer by reacting the activatable polysaccharide polymer or polysaccharide polymer with an additional activatable crosslinker with a crosslinking initiator for crosslinking the polysaccharide polymer chains with each other, for preparing a product such as hydrogel, film, coating or membrane with polysaccharide backbone.

### FIELD OF THE INVENTION

The invention relates to a method for preparation of products from a polysaccharide molecule by a coupling or a crosslinking technique defined in claim 1.

### BACKGROUND

A lot of research is being made in the area of replacing fossil fuel-based with bio-based starting materials in polymer synthesis. Bio-based polymers such as hemicellulose, cellulose or cellulose fibre and their derivatives are recently studied and used, for example, as crosslinking and reactive components in adhesives, paints, or coatings [Glasser et al. 1995, X2], and often used together with crosslinking and/or coupling agents.

The properties such as mechanical strength or water adsorptivity are often adjusted using crosslinkers. [Cuggino et al. 2008]. These crosslinking components may also be carbohydrate based derivatives such as diallylamide of tartaric acid [Anker 1970]. These bio-based products are of interest not only for their renewable character but because they may offer biocompatibility and/or biodegradability and other improved material properties. One example of these materials are cellulose based hydrogels that are often prepared by using radical polymerization. [Lindblad et al. 2005, Oh et al. 2009] Such materials could be used in tissue engineering, controlled drug release, agriculture, or in hygiene products.

The utilization of hemicelluloses as starting materials offers a way to exploit them because they have so far found only limited application in industry and are normally disposed of as organic waste from the forest industry side streams or used as raw materials for the production of xylose and other monosaccharides.

### DESCRIPTION

Commercial hydrogels, membranes and films have traditionally been prepared mainly from acrylamides and acrylates [Mohan et al. 2005]. Acrylamides and acrylates when not polymerized are very toxic substances and thus not very nice to work with. Acrylamides and acrylates are fossil fuel-based chemicals.

A general objective of the invention is to develop new routes and techniques for exploiting bio-based starting materials such as hemicellulose and cellulose pulps for preparing different products and materials to various applications while getting rid off inconveniences of the prior art. Therefore the first general objective of the present invention is to replace these acrylamides and acrylates with bio-based starting materials, which would guarantee that no harmful substances would be released into nature.

Another general approach of the present invention is to achieve new bio-based products and applications by using new methods and starting materials. These products include at least following: hydrogels, films, membranes, composition materials, plastics, coating materials, binders, coatings, beads and particles.

The starting materials used in the invention comprise bio-based polysaccharide molecule or fibre, preferably hemicellulose or cellulose and may come from waste or side streams of food or forest industry, which makes the process very ecological.

Generally speaking, one of the main ideas behind the invention is to use polysaccharide molecule, preferable cellulose or hemicellulose molecule, which contains numerous coupling substituents forming multicrosslinking polysaccharide for preparing different products. When the same polysaccharide molecule has numerous coupling-substituents which can be used for crosslinking reactions between same or different polysaccharide polymers and also in other chemical reactions, for example in grafting or coupling reactions for making co-polymers between polysaccharide and another kind of polymer or polysaccharide, one can achieve products with certain “tailored” three-dimensional structure and properties. Properties of these products can also be affected by selection of the preparation process; hydrogel vs. film vs. membrane made by grafting method vs. coupling method.

Another general idea behind the invention is to use polysaccharide molecules, preferably fibres containing cellulose or hemicellulose polymer as a starting material in the process according to invention. Polysaccharide molecule, which is used as a starting material for preparing these new products, is modified to its ether or ester derivatives with known methods. This modified polysaccharide molecule is then provided with numerous coupling substituents for crosslinking, grafting or coupling purposes. This means here that the same polysaccharide may contain several structurally and functionally same or several kind of functional groups, for example, allyl and epoxy groups which enable different coupling, crosslinking, and/or grafting reactions.

When a polysaccharide molecule is provided with numerous coupling substituents this polysaccharide is thereinafter called also as multicrosslinking polysaccharide or as a multireactive macromolecular compound, since it can take part of different kind of (coupling) reactions. In a normal case, a polysaccharide polymer contains at least 5-10 same or different kind of coupling substituents. When one polysaccharide molecule contains numerous coupling substituents with the same or different structure these coupling substituents can act as an coupling agent in at least two different type of coupling reactions (crosslinking, coupling, grafting).

These coupling substituents can be used for crosslinking at least two same or different kind of polysaccharide molecules with each other or coupling or making internal crosslinking bonds at least between two coupling substituents within the same kind of polysaccharide molecule. These same crosslinking substituents may be used also for crosslinking or coupling modified polysaccharide into other polymer (making copolymers) such as polyvinyl alcohol or polyalkylamine or by grafting numerous non-polysaccharide monomers on said polysaccharide chain (co-polymerization). Said coupling substituents such as epoxy groups can be also used for coupling said polysaccharide molecule with additional crosslinking agents. The polysaccharide molecule containing numerous same kind or different kind of coupling substituents may be called also as a macromolecular crosslinker or multireactive macromolecular compound.

By coupling or grafting modified polysaccharide with suitable momomer(s) yielding polymeric groups one can also bring stimuli-responsive properties onto a polysaccharide molecule. Polysaccharide molecule may also be tailored with other groups which can take or do not take part of above mentioned coupling or grafting reactions. These groups are used with an adjusted degree of substitution (DS) to polysaccharide molecule and they can bring chemical modifications for adjusting absorptivity, solubility, polarity, mechanical strength, hydrophobic-hydrophilic balance of the final product.

Different kinds of starting polysaccharide materials such as cellulose or (hetero)xylans from wood or agricultural sources can be used as starting materials. Cellulose can contain mainly crystalline cellulose or different grades of cellulose fibers; among others, it can contain called regenerated cellulose (for example cellophane) or microfibrillated cellulose (for example so called nanocellulose or microcellulose). Hemicellulose can be for example starch, xylans, heteroxylans such as arabinoxylans, (galacto)glucomannans or arabinogalactans. Also chitosans or different pectins can be used as a starting material if it is desirable that the starting material contains also other possible functional groups than hydroxyl groups.

The schemes IA and IB below present the general method for preparing different products from a multireactive macromolecule when the multireactive macromolecule is a modified polysaccharide molecule, especially modified hemicellulose molecule.

Scheme IA. The general strategy to prepare different kind of products from one single tailored polysaccharide using different kind of manufacturing processes is shown in scheme IA.

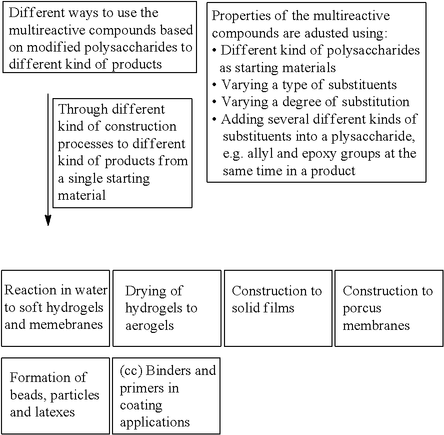

Scheme IB presents the general methods for preparing multireactive compounds of scheme IA from polysaccharide starting material, especially when starting material is hemicellulose and subsequently the use of these multireactive polysaccharide compounds for producing various products, see also Scheme IIA for reaction routes. R₁=H (pentoses such as xylose or arabinose) or R₁=OH (hexoses such as glucose, galactose, mannose) or R₁=CH₃ (eg. rhamnose) or R₁=COOH (eg. galacturonic acid) or OR where R=H or a substituent prepared using either Williamson route (1) using R-X reagents (where X is a halogen atom such as Cl, Br, or I), or glycidyl routes (2 and 3), or combination of them (2+1) or (2+3). Epoxydation of doubles bond (4) is one possible option for several further modifications. R*=alkyl substituents with chain lengths (C1-C18, branched or not) which can contain other functionalities such as ether, epoxy, amino, carboxylic groups, double bonds, halogen atoms, aldehydes.

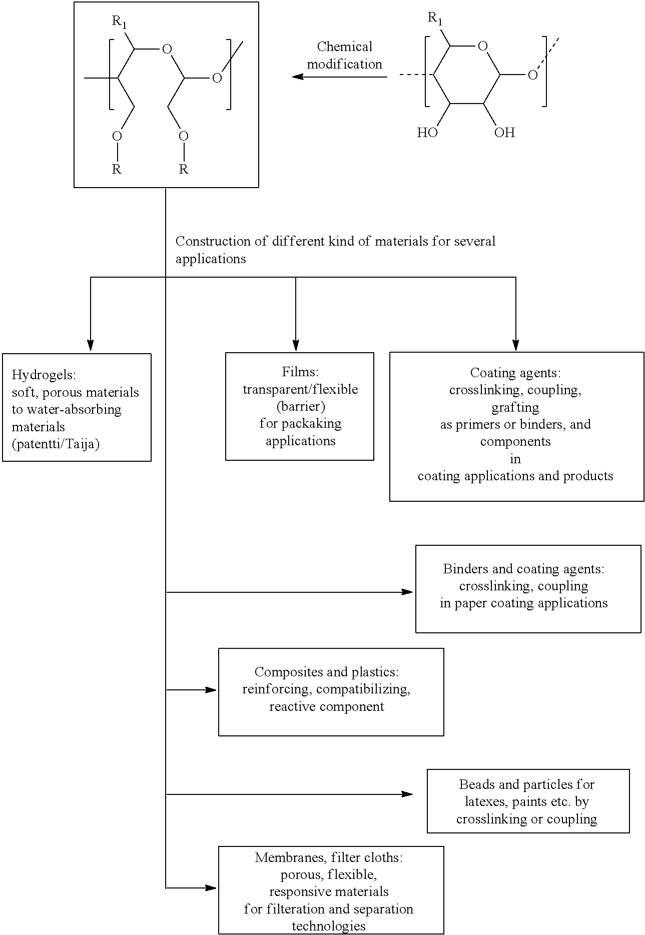

By using processes and techniques presented in above presented general schemes I one can prepare improved novel products from multireactive polysaccharides. Therefore invention relates to improvement of novel products with tailored properties such as adjusted water-absorbing properties in hydrogel-like products or specific adsorptivity or selective permeability in fiber-, membrane- or film-like materials.

By using multireactive polysaccharide compounds having numerous same kind or different kind of coupling substituents, one can improve and bring excellent properties on films and coatings and other applications. These applications include, for example, barrier materials in packaging applications, or membrane-type or fibre-type materials with improved and/or adjustable permeability and/or selective absorptivity and/or antifouling properties, for example, against water, ions, organic pollutants etc. New coating can be made by combining polysaccharide derivatives into or onto a polymer matrix. For example coatings can be made, by crosslinking or coupling reactive polysaccharides, preferably based on cellulose or hemicellulose derivatives into polyvinylalcohols or onto polyvinylalcohol-based fibres or other polymeric fibres or surfaces.

Depending on the quality and state of the starting material (polysaccharide), the kind of used coupling substituents, the polymer to be grafted or coupled on said polysaccharide, different products can be made.

Polysaccharide based hydrogels can be made for various applications. These include different kinds of absorbent hygiene products such as baby diapers and feminine hygiene products. Wet wipes such as household cleaning wipes, personal care wipes and baby wipes are also promising applications.

New tailored biobased components as crosslinking and/or coupling agents and/or reinforcing agents can be used, for instance, as components in applications and products such as hydrogels, absorbent materials, and/or membrane type of materials.

If the starting material comprise mainly fibres containing cellulose or hemicellulose, one can, for example made reinforced fibre composites by coupling this fibre cellulose into polymer matrix.

The properties of polysaccharide derivatives can be tailored according to the needs of applications, for example in coatings, paints, adhesive, or as construction materials or in composites or in membranes or fibre-based materials comprising usually copolymers of polysaccharide and suitable polymer(s) used in this application.

For example, the hydrophility-hydrophobicity balance of the polysaccharide matrix can be modified by coupling or grafting suitable groups onto polysaccharide matrix. For example substituents comprising alkyl esters and/or alkyl ethers can be attached onto cellulose or hemicellulose matrix for modifying water uptake of the matrix material.

Scheme IIA shows the general methods to prepare multireactive polysaccharide compounds which can be used for preparing different kind of products.

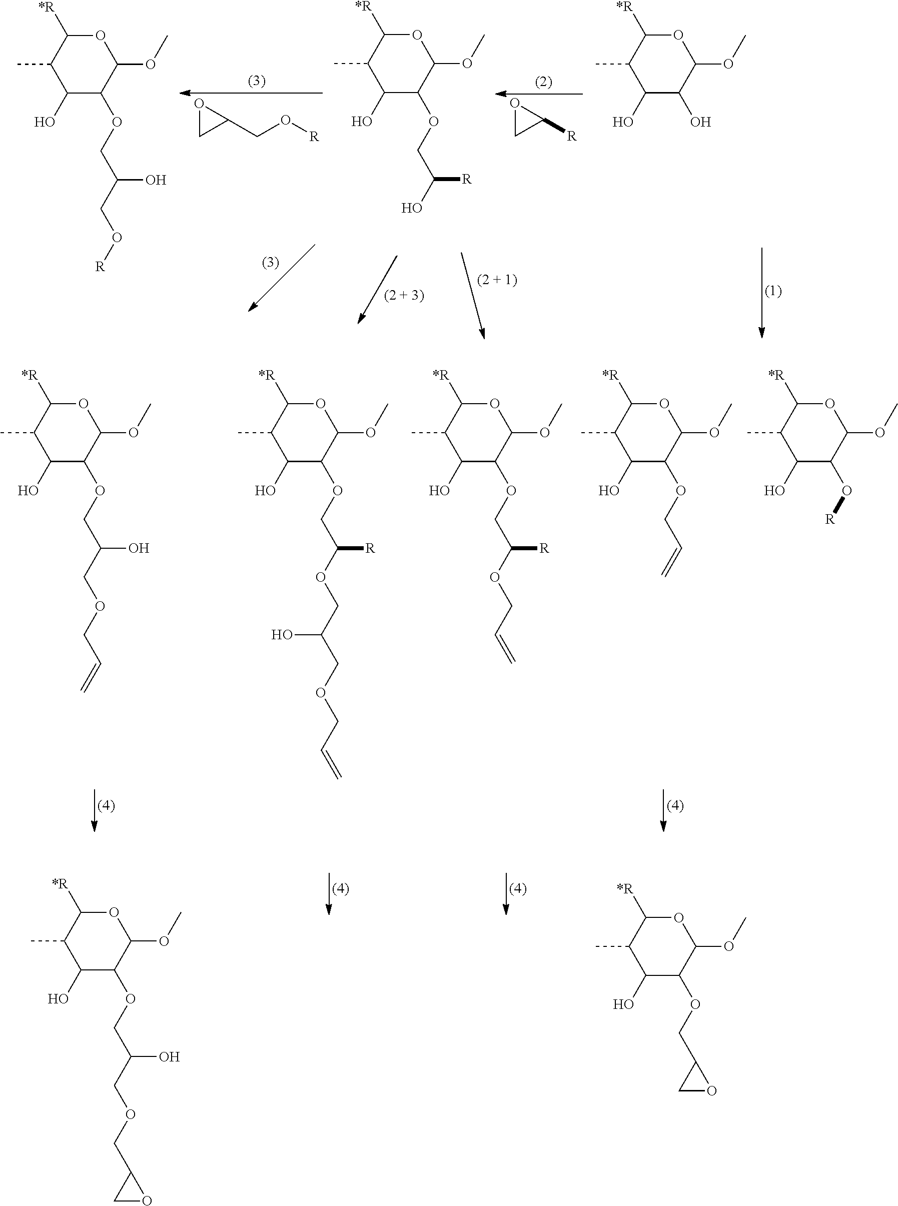

The scheme IIA presents an overall modification strategy for cellulose or hemicellulose based polymers using either (1) Williamson etherification or (2) hydroxyalkylation, or (3) glycidyl ether routes, where R (see Figure X) can be a suitable functional, reactive, or other substituent giving improved and adjusted properties for a polysaccharide derivative. R* is usually H in pentose based polysaccharides such as anhydroxylose units in xylans, and R*=CH₂OH in hexose based polysaccharides such as anhydroglucose units in celluloses. Modification route (4) is an optimal route and an example of many possible further modification routes for double bonds.

Scheme IIB presents the other examples of products that are possible to prepare via the route 4.

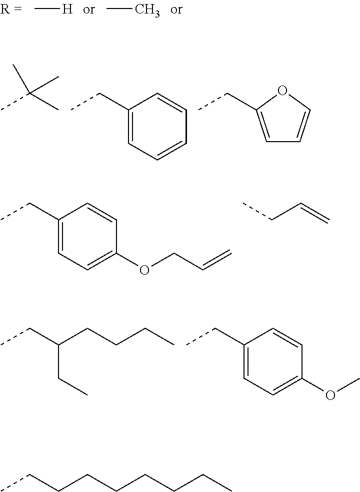

Scheme IIC shows some possible further modification routes, for example, for allylic double bonds. Some possible substituent R in glycidyl, epoxy, or alkyl halide reagents.

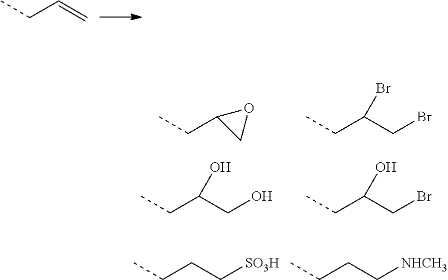

As can be seen from reaction scheme II, multireactive polysaccharide compounds, containing numerous coupling substituents, can be made using different routes and the techniques for introducing different reactive groups into polysaccharide molecule. Free hydroxyl groups of a polysaccharide molecule can modified via different routes for making polysaccharide ethers which have numerous coupling substituents. Depending on the structure of the coupling substituent, it can be introduced into free hydroxyl group of a polysaccharide molecule using a single reagent or series of reaction steps with multiple reagents. In reaction scheme I it has been presented only some possible methods for introducing numerous coupling substituents into a polysaccharide molecule.

Crosslinking reactions used in the process presented in general scheme I or II are usually using following reaction schemes (1-4):

Crosslinking reaction with other polysaccharide molecule (A can be the same or different polysaccharide as B):

AS₁-(R₁)ₙ+(R₂)ₘ-BS₂->(AS₁-(R₁-R₂)ₙ₊ₘ₋₂ₓ-BS₂) (1)

Crosslinking reaction using an additional coupling agent

AS₁-(R₁)ₙ+BS₂-(R₂)ₘ+xZ->(AS₁-(R₁)ₙ₋ₓ-Zₙ₋ₓ-(R₂)ₘ₋ₓ-BS₂) (2)

Grafting monomer M on a polysaccharide

AC-(R₁)ₙ+xM->AC-(R₁)ₙ₋ₓ-co-poly(M) (3).

Coupling polysaccharide with a polymer

AC-(R₁)ₙ+xpoly(M)->AC-(R₁)ₙ₋ₓ-co-poly(M) (4).

wherein
A and B means independently from each other the same or different kind of polysaccharide molecule;
S₁ and S₂ means independently from each other the same or different kind of non-reactive substituent of said polysaccharide molecule A or B;
R₁ and R₂ means independently from each other the same or different substituents containing a reactive double bond in a case of radical reaction, or related crosslinking, or polymerization reactions;
otherwise R₁ and R₂ means independently from each other reactive substituents, which may form together a coupling; a coupling can be formed for example, between an epoxy group and hydroxyl, amino, or carboxylic group;
Z is an additional coupling reagent forming an additional coupling agent between R₁ and R₂. Z contains at least on double bond in case of radical reactions, otherwise Z is an additional coupling reagent used in polysaccharide chemistry which contains at least two groups, which can be reacted with R, and/or R₂;
M is a monomer containing at least one double bond in a case of a radical reaction or a substituent enabling grafting monomer(s) on R₁ or R₂;
Poly(M) is a polymer made of monomer(s) M by polymerization;
n and m is the number of (reactive) substituents in one polysaccharide molecule, n or m is between 5 to 1000, typically in the range of 10-100;
the degree of substitution (DS) of R₁, R₂ to the free hydroxyl groups of polysaccharide polymer is between 0.01 to about 1 and
x is the number of coupling substituents reacted with each other, additional crosslinking reagents, monomers, or polymers, whereby in reaction (1) x means the number of coupling substituents reacted with each other, in reaction (2) x signifies the number of coupling substituents reacted with additional coupling agents, in reaction (3) x signifies the number of coupling substituents onto which the monomers of the polymer have been grafted (that means that the reaction (3) will not define how long the copolymer to be grafted can be) and in reaction (4) x signifies the number of coupling substituents, which have contacted with specific groups of polymer (M).

In above reactions (1)-(4) coupling substituents are denoted as R₁ or R₂ which can be used for grafting or other kind of reactions.

R₁ or R₂ include preferably substituent comprising one of the following functionalities: unsaturated group (includes a reactive double bond functionality in case reaction (1) proceeds according to a radical reaction or related crosslinking or polymerization reactions), vinyl, allyl, acrylic, acrylamide, amino, carbonyl, epoxy, hydroxyl or isocyanate.

The additional coupling agent denoted as Z, contains preferably at least two of the following functionalities: unsaturated group, vinyl, allyl, acrylic, acrylamide, amino, carbonyl, epoxy, hydroxyl or isocyanate, hydroxyl, epoxy, carboxylic, amino, or isocyanate reacting with suitable R₁ and/or R₂ substituents.

Unsaturated group means herein an aliphatic group with unsaturation in its carbon backbone, preferably unsaturated group means alkenyl having an unsaturated terminal group, for example allyl or vinyl group.

Epoxy functionality comprises herein preferably epoxides including glycidyls and glycidyl ethers such as lower alkyl glycidyl ethers and lower alkenyl glycidyl ethers, monoepoxides such as lower alkylene ethers including ethylene oxide, propylene oxide and 1,2-epoxubutane and 1,2-epoxyhexane.

Acrylate may be a commercial coupling agent such as methacrylate while acrylamide can be a commercial coupling agent such as N,N′-methylenebisacrylamide.

Carbonyl means preferably a residue originating to a mono or dicarboxylic acid or their anhydrides or halides. As stated before, R₂ or R₁ is connected to the carbon backbone of polysaccharide polymer via ether or ester bond, preferably via ether bond. More preferably there exists numerous, for example at least two ether bonded R₂ or/and R₁ and additionally some R₂ or R₁ maybe bonded with esters bond to polysaccharide carbon backbone.

M is a monomer containing at least one double bond in a case of a radical reaction or a monomer enabling grafting reaction onto R₁ or R₂ in case of other polymerization or coupling reactions. Preferably monomer M has a reactive group selected from the group consisting of: amino, acrylamide, alkylacrylamide, carboxylic, ethenyl, halogen, epoxy or —SO₃.

Poly(M) in reaction (4) is a suitable polymer, such as polyvinyl alkohol, which can be bonded to R₁ or R₂.

S₂ and S₂ may be an alkyl chain adjusting, for example, hydrophility-hydrophobicity balance of polysaccharide chain, solubility, etc. (C=C′ or C is not C′). These substituents do not take part to the reactions 1-4.

In one preferred embodiment of the present invention the additional coupling agent Z is an organic moiety containing diacid and/or dihydroxy functionality preferably aldaric acid or its derivative of the formula (II)

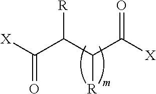

wherein
R represents a substituent selected from the group consisting of hydroxy, hydroxyl or OCO(CH₂)ₙCH₃ or O(CH2)ₙCH₃ and wherein n is a total number from 1 to 14,
X represents a substituent selected from: hydroxyl, lower alkyloxy, aryloxy, halogen, —NHR′ or NH(CH₂)ₙCH═CH₂ or NH(CH₂)ₙCH(O)CH₂, wherein
R′ represents C₂-C₁₆-hydrocarbyl containing a residue comprising terminal unsaturation such as an allyl group, an epoxy residue or an amino residue,
m is a total number from 1 to 3: for preparing an activated xylan polymer with an additional mentioned crosslinker Z.

More preferably X means hydroxyl group and R is hydroxyl or lower alkoxy or alkanoate. The aldaric acid derivative is preferably allylamide based aldaric acid derivative.

### Hydrogels, Membranes and (Packaging) Films

The general method for preparing a membrane, hydrogel or film when starting material is cellulose or hemicellulose begins by introducing into numerous free hydroxyl groups of cellulose or hemicellulose polymer numerous reactive substituents (coupling substituents). This can be done according to methods presented in general scheme II (above) by etherifying and additionally esterifying some or all hydroxyl groups of said cellulose or hemicellulose polymer. This method produces a multireactive cellulose or hemicellulose compound which is used for reactions (1)-(4) as follows:

The first cellulose or hemicellulose molecule with numerous coupling substituents is crosslinked with a second cellulose or hemicellulose chain provided with a numerous coupling substituent. Crosslinking is done by activating possible dissolved or fibrous cellulose or hemicellulose polymer with a reaction initiator such as photoinitiator. During the process of preparing hydrogels and membranes the activation of suitable coupling substituents is done mainly in the presence of aqueous solution whereas during the process of preparing films activation of coupling substituents is done mainly without aqueous solution or in the presence of a small amount of aqueous solution. So, this reaction step can be presented as follows with reaction scheme (1) in reaction step (a1):

(a1) crosslinking cellulose or hemicellulose polymer (A) provided with numerous coupling substituents with a second cellulose or hemicellulose polymer (B) provided with numerous coupling substituents by activating possibly dissolved cellulose or hemicellulose polymer with a reaction initiator such as photoinitiator, whereby the reaction is performed according to general reaction (1)

AS₁-(R₁)ₙ+(R₂)ₘ-BS₂->(AS₁-(R₁-R₂)ₙ₊ₘ₋₂ₓ-BS₂) (1).

Polysaccharide molecules A and B can also be crosslinked together using an additional coupling reagent Z according to general reaction (2) of reactions step (a2):

AS₁-(R₁)ₙ+BS₂-(R₂)ₘ+xZ->(AS₁-(R₁)ₙ₋ₓ-Zₙ₋ₓ-(R₂)ₘ₋ₓ-BS₂) (2).

For modifying the properties of the membrane, hydrogel or film to be prepared the cellulose or hemicellulose molecule provided with numerous coupling substituents can also undergo reactions 3 or 4 of corresponding reaction steps b1 or b2 before, after or simultaneously of reaction steps a1 and a2 (below is presented reactions for molecule A, the molecule B is modified accordingly):

(b1) reacting cellulose or hemicellulose polymer (A) provided with numerous coupling substituents (A) with monomer(s) (M) according to general reaction (3)

AC-(R₁)ₙ+xM->AC-(R₁)ₙ₋ₓ-co-poly(M) (3)

and/or
(b2) coupling said cellulose or hemicellulose polymer (A) with polymer poly(M) made of monomers M according to general reaction (4):

AC-(R₁)ₙ+poly(M)->AC-(R₁)ₙ₋ₓ-co-poly(M) (4)

wherein
A and B means independently from each other the same or different kind of polysaccharide molecule and if A and B means the same kind of polysaccharide molecule crosslinking reactions (1) can be performed between same polysaccharide polymer (intramolecular crosslinking),
S₁ and S₂ means independently from each other same or different kind of non-coupling substituents of said polysaccharide molecule A or B,
R₁ and R₂ means independently from each other the same or different coupling substituents containing a reactive double bond in a case of radical reaction or related crosslinking, or polymerization reactions and bonded to said polysaccharide molecule A or B via ether or ester bonding preferably via ether bonding,
otherwise R₁ and R₂ means independently from each other reactive substituents, which may form together a coupling,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
whereby the degree of substitution (DS) of the hydroxyl groups with coupling substituents to the polysaccharide is between 0.01 to about 1
and
x is the number of reacted coupling substituents whereby in reaction (1) x means the number of coupling substituents reacted with each other, in reaction (2) x signifies the number of coupling substituents reacted with additional coupling agents, in reaction (3) x signifies the number of coupling substituents onto which the monomers of the polymer have been grafted and in reaction (4) x signifies the number of coupling substituents, which have contacted with specific groups of polymer (M).

The general method for preparing hydrogels, films and membranes is outlined above by process steps a1, a2, b1 and b2 and is also described in general scheme I and II.

One important embodiment of the invention relates for preparing new hydrogels by using proceed outlined in process steps a1, a2, b1 and b2, and using in the step a2 new additional coupling agents basing on the use of carbohydrate diacids such as aldaric acids. This embodiment is based on the following sub-ideas:
(a1) providing hemicellulose or cellulose ether derivatives, such as hydroxypropyl cellulose with numerous coupling substituent, according to reaction (1)

AS₁-(R₁)ₙ+(R₂)ₘ-BS₂->(AS₁-(R₁-R₂)ₙ₊ₘ₋₂ₓ-BS₂) (1),

wherein A, B, S1, S2, m, n, x and DS are defined as above,
(a2) modifying aldaric acid (carbohydrate diacid) to its activated derivative and attaching additional coupling reagent with the coupling substituent of hemicellulose or cellulose ether from previous process step (a1) and then using this additional coupling agent for coupling molecules A and B together according to general reaction (2)

AS₁-(R₁)ₙ+BS₂-(R₂)ₘ+xZ->(AS₁-(R₁)ₙ₋ₓ-Zₙ₋ₓ-(R₂)ₘ₋ₓ-BS₂) (2).,

wherein A, B, S1, S2, m, n, x and DS, Z are defined as above, and
(b3) further using hemicellulose or cellulose molecules, substituted with additional coupling agents Z from stage (a2) for cross-linking reactions between polysaccharide molecules (A) and (B) in the presence of aqueous medium for producing hydrogel. Crosslinking of polysaccharide molecules (a) and (B) with each other, by using hemicellulose or cellulose molecules, which contains numerous coupling substituents, which are further coupled together with additional coupling agents, proceeds as presented via reaction (1).

Hydrogels are chemically or physicallyⁱ crosslinked networks that are water-insoluble but capable of absorbing large amounts of water. They can be made of synthetic or natural starting materials but commercial hydrogels have traditionally been prepared mainly from toxic acrylates and acrylamides.ⁱⁱ

Hydrogels based on naturally occurring products are of interest not only for their renewable character and nontoxic nature but because they may offer biocompatibility and biodegradability. Hydrogels possess a degree of flexibility due to their significant water content and they are potential material candidates, for example, in tissue engineering,ⁱⁱⁱ controlled drug release,^{iv,v} agriculture_{vi,vii} and hygiene products.^{viii} Especially beneficial in applications is the obvious biodegradability of polysaccharide and aldaric acid based materials.

Carbohydrates are a class of natural products that are widely available in nature. They have a wide variety of functionality and they are very hydrophilic which make them good candidates for hydrogel preparation. Hemicelluloses, such as xylan, have hydroxyl groups in each repeating unit which can be chemically derivatized to new reacting groups. When compared with cellulose and starch, hemicelluloses have been somewhat neglected in research and they are normally disposed of as organic waste from the forest industry sidestreams. However, recent research has begun to find new applications for hemicelluloses and examples of hydrogels prepared from modified hemicelluloses can be found.^{ix,x,xi,xii}

Hemicelluloses can also be hydrolysed to monosaccharides to obtain e.g. xylose, arabinose, galactose and mannose which can be oxidized to aldaric acids. Typically aldaric acids are produced with simple chemical oxidations of sugars, but the aldaric acids can be selected of a group which is optionally produceable biotechnically.^{xiii} Aldaric acids are starting materials with difunctionality which is a key factor when synthesizing crosslinkers. The diacids can be reacted to activated compounds, such as allyl functionalized monomers. Some syntheses of N,N′-diallylaldardiamides have been described in the literature but none starting from bio-based starting materials. Anker^{xiv} has reported the preparation of polyacrylamide gels using (+)-N,N′-diallyltartardiamide as a crosslinker instead of the normally used methylenebisacrylamide (MBA). Two references of N,N′-diallylgalactardiamide (DAG)^{xv,xvi} and one of N,N′-diallylxylardiamide (DAX)^{xv} were found. No references for N,N′-diallylarabinardiamide (DAA) were found.

The preparation of hydrogels is illustrated later in a more detailer way.

The prepared hydrogels originate mainly to bio-based starting materials but they can be combined also with other monomers or polymers for example by using grafting techniques of reaction scheme (3) as defined above. Such monomers or polymers include for example acryl amides or acrylates.

Polysaccharides such as xylan or cellulose and their derivatives as starting material and aldaric acid derivatives as crosslinkers have not been used before in the preparation of hydrogels.

In a more detailed manner cellulose, lignocellulose or hemicellulose molecule based materials such as cellulose, lignocellulose or hemicellulose fibres, were first (1) modified to their free hydroxyl groups with coupling substituents containing allylic, acrylic, epoxy, amino, or acrylamide functionalities (FIGS. 1-3), and then (2) allyl, acrylate, or acrylamide groups containing monomers were grafted on said coupling substituents with adjusted degree and ratio (FIG. 4). Alternatively cellulose, lignocellulose or hemicellulose molecule based materials such as cellulose, lignocellulose or hemicellulose fibres, were (1) substituted to their free hydroxyl groups with substituent containing allylic, acrylic, epoxy, amino, or acrylamide functionalities and (3) these coupling substituents were grafted further with novel coupling agent monomers such as aldaric acids, or diallylamide or diepoxy derivatives of aldaric acids (FIG. 5), aldaric acid based substituents or with commercial crosslinkers such as N,N′-methylenebisacrylamide (MBA) or diepoxy compounds such as diethylene glycol diglycidyl ether. These cellulose, lignocellulose or hemicellulose molecule based polymeric materials which have multicrosslinking substituents (4) containing multifunctional coupling substituents possibly including additional coupling agents were used in novel construction methods for preparing film or membrane type of materials. The examples of these techniques used together or separately in a certain order will be given later.

Carbohydrate based aldaric acid derivatives (FIG. 5) were used as crosslinkers or in grafting reactions either in radical polymerization or in epoxy based chemistry with different monomers and/or (bio)polymers yielding polymeric networks such as hydrogels, membranes, or films, for example, when grafted with tailored water-absorption and/or ion-exchange and/or stimuli-responsive properties. Aldaric acids such as galactaric acid (mucic acid), xylaric acid, arabinaric acid, and polysaccharides such as cellulose and xylan are used as starting materials as such or as their derivatized forms. Polysaccharides were derivatized to different degrees of substitution to ester, amides, or ethers groups containing functionalities such as acryl, allyl or related with double bonds, alkyl, alkoxy and/or epoxy (FIGS. 1-3).

Preparation of a hydrogel from a xylan polysaccharide in which at least one hydroxyl of a pyranose unit is substituted with an ether or ester moiety is performed as follows:
said ether or ester moiety is further reacted with a reagent, which has an ethenyl and/or epoxy functionality for preparing an activatable xylan polymer,
the activatable xylan polymer with ethenyl and/or epoxy functionality is optionally reacted with an additional crosslinking reagent, having at least two crosslinking functionality for preparing xylan polymer with additional activatable crosslinker,
the activatable xylan polymer or xylan polymer with an additional activatable crosslinker, is activated for crosslinking by reacting said activatable xylan polymer or xylan polymer with an additional activatable crosslinker with a crosslinking iniator for crosslinking the xylan polymer chains with each other for preparing a hydrogel with a xylan backbone.

The reagent with an allyl and/or epoxy residue is preferably an allyl glycidyl ether or a glycidyl ether residue.

Hydrogel may also contain xylan polymer backbone in which at least one hydroxyl of a pyranose unit is substituted with an ether or ester moiety, wherein at least one ether or ester moiety further contains substituent selected from the group containing an allyl glycidyl ether or a glycidyl ether residue.

Hydrogel may even contain xylan polymer backbone in which at least one hydroxyl of a pyranose unit is substituted with an ether or ester moiety, wherein said ether or ester moiety further contains substituent selected from the group containing of an residue having an ethenyl and/or epoxy functionality and whereby said ethenyl and/or epoxy functionality substituted ether or ether moiety contains also an additional crosslinking substituent having at least two crosslinking functionality.

Preferably an additional crosslinking substituent is obtained by oxidation of a monosaccharide preferably a monosaccharide obtained from hemicellulose.

Preferably the additional crosslinking reagent is an organic moiety containing diacid and/or dihydroxy functionality preferably aldaric acid or its derivative of the formula (II)

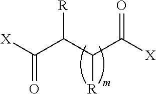

wherein
R represents a substituent selected from the group consisting of hydroxy, hydroxyl or OCOCH₂)ₙCH₃ or O(CH₂)ₙCH₃ and wherein n is a total number from 1 to 14,
X represents a substituent selected from: hydroxyl, lower alkyoxy, aryloxy, halogen, —NHR′ or
NH(CH₂)ₙCH═CH₂ or NH(CH₂)ₙCH(O)CH₂, wherein
R′ represents C₂-C₁₆-hydrocarbyl containing an allyl, an epoxy or an amino residue,
m is a total number from 1 to 3 for preparing an activated xylan polymer with an additional crosslinker.

More preferably X means hydroxyl group and R is hydroxyl or lower alkoxy wherein the aldaric acid derivative is allylamide based aldaric acid derivative.

Novel xylan based hydrogels have been prepared in water solution by crosslinking xylan derived polymers with or without N,N′-diallylaldardiamides.

Xylan polymer was first derivatized to different degrees of substitution of allyl groups. Examples from literature can be found where polysaccharides have been derivatized with allyl groups, e.g. Huijbrechts et al.^{xvii} have modified starch with allyl glycidyl ether and investigated their physicochemical properties compared to native starch. Shen et al.^{xviii} have modified carboxymethyl cellulose to obtain an allyl functionalized derivative, N-allylcarbamoylmethyl cellulose, for hydrogel preparation. The crosslinkers were prepared starting with aldaric acids. We chose aldaric acid based allylamides as crosslinkers not only because they are bio-based but because this choice allows us to carry out the crosslinking reaction in water. Xylan derived polymers were crosslinked without crosslinker and also with four different crosslinkers (DAT, DAX, DAA, and DAG). The morphological and swelling properties of the hydrogels were determined.

N,N′-diallylaldardiamides were synthesized from galactaric, xylaric and arabinaric acids. Hydrogels were prepared in water solution by UV induced free-radical crosslinking polymerization of derivatized xylan polymers without crosslinker or in the presence of 1 or 5 mass-% of N,N′-diallylaldardiamide crosslinker. Commercially available (+)-N,N′-diallyltartardiamide (DAT) was also used. Xylan polymers with different degrees of substitution of allyl groups were analyzed according to ¹H-NMR spectra. Elemental analysis proved the crosslinking successful. Water absorption of the gels was examined and the most absorbing gels were derivatives of xylan polymer with a degree of substitution of allyl groups 0.4. The presence of crosslinker had no significant impact on the water absorbency but a more uniform pore structure was achieved. The swollen morphology of the hydrogels was assessed by scanning electron microscopy.

Novel hydrogels were synthesized using bio-based starting materials. Hydroxypropylated xylan was derivatised to different degrees of substitution of allyl groups. The sugar diacids for crosslinkers can be obtained from waste biomass and derivatising them chemically to N,N′-diallylaldardiamides. The best water absorbancy was achieved with gels made from xylan polymer with the degree of allyl group substitution of 0.4. The amount of crosslinker had no significant influence on the water absorbency but the presence of a crosslinker improved the structure of the gels by giving them a uniform pore structure.

### Synthesis of the Crosslinkers

Three different crosslinkers were synthesized from aldaric acids.

Scheme 1 shows the schematic reaction route for the synthesis of the crosslinkers. Arabinaric and xylaric acids were synthesized according to the literature^{xix} from arabinose and xylose, respectively. Galactaric acid (mucic acid) was commercially available. All the diacids were esterified with methanol^{xx} and subsequently reacted with allylamine in dry tetrahydrofuran^{xiv} to obtain white crystals. The crosslinkers were verified by ¹H NMR and ¹³C NMR. A representative ¹H NMR spectrum of N,N′-diallylgalactardiamide (DAG) is shown in Figure A.

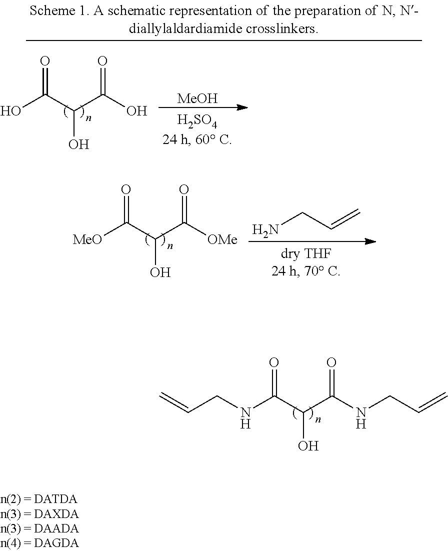

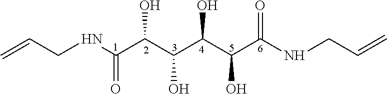 [SMILES: C=CCNC(=O)[C@@H](O)[C@H](O)[C@H](O)[C@@H](O)C(=O)NCC=C]

### Derivatisation of Xylan Polymer

Never-dried (5-10 wt-%, containing 0.9% NaOH) or dried xylans extracted, for example, from (bleached) birch pulp were used as starting materials.^{xxi} Hydroxypropylation of xylan was performed according to literature.^{xxii} Hydroxypropylated xylan was reacted in alkaline conditions with allyl glycidyl ether and/or butylglycidyl ether to obtain three different xylan derivatives (HPX-BA, HPX-A and X-BA) with different structures and degrees of substitution of allyl groups (Figure E). The degree of substitution (DS) of the xylan derivatives was determined by the integration of ¹H NMR spectra (Figure B, Figure C and Figure D).

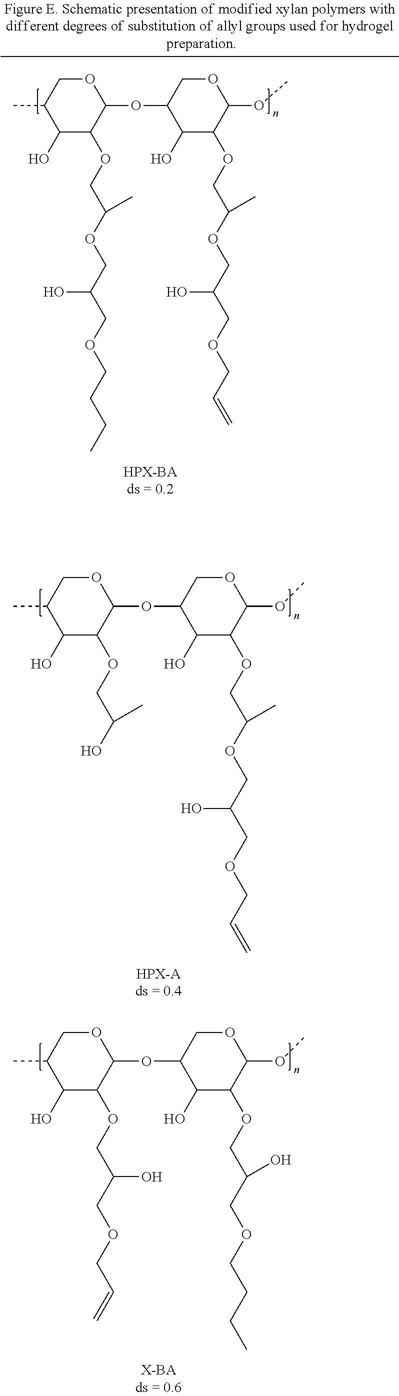

### Preparation of Hydrogels

The hydrogels were prepared by crosslinking the xylan derivatives without a crosslinker or by inserting the crosslinker between the xylan polymer chains. The crosslinking was done in 10% water solution of the xylan polymer. The crosslinkers were dissolved in water prior to mixing with the polymer solution. DAG required some heating for dissolution in water. Potassium persulfate was used as the photoinitiator and it was dissolved in a small amount of water prior to mixing with the solution of xylan polymer and the crosslinker. Samples were put on Petri dishes and exposed to UV light in an UV oven. The samples were irradiated in 30 s periods and let to cool down in between because the oven and the samples became quite hot. The gels were irradiated for 3 to 4 minutes and Figure G shows an example of a crosslinked xylan derivative. The amount of crosslinker could be seen from the gels right after the crosslinking. The gels with 1 mass-% of crosslinker were semi-opaque whereas the gels with 5 mass-% of crosslinker turned almost white. The gels with xylan polymer without crosslinker were almost transparent.

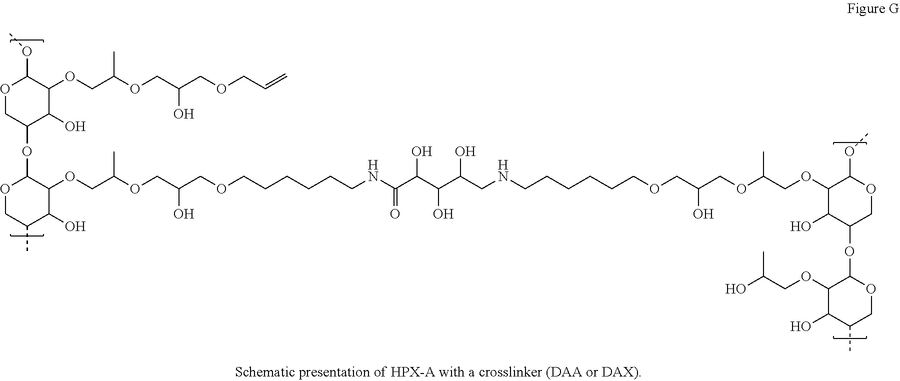

### Elemental Analysis

The crosslinked hydrogels were analyzed for their nitrogen content to prove the crosslinking reaction successful. Varying amounts of nitrogen were found. The elemental analysis for the samples crosslinked with 5 mass-% of crosslinker gave clear indication of the presence of nitrogen (Table

1) whereas the results for the samples with 1 mass-% of crosslinker were on the detection limit. Differences in nitrogen contents may be due to reactivity differences of the crosslinkers.

TABLE 1
The amounts of crosslinkers in mass-% found in
elemental analysis of nitrogen by Kjeldahl method for hydrogels
crosslinked with 5 mass-% of crosslinker.

| | HPX-A (wt-%) | HPX-BA (wt-%) | X-BA (wt-%) |
|---|---|---|---|
| DAT | 3.86 | 3.79 | 2.07 |
| DAA | 3.53 | 2.96 | 1.56 |
| DAX | 2.63 | 2.22 | 1.48 |
| DAG | 3.72 | 3.34 | 1.67 |

### Crosslink Certification Using a Bromination Method.

The crosslinking of xylan derivatives without crosslinkers was proved using a bromination method of allylic double bonds with bromine. The bromine content was analyzed using a so-called instrumental neutron-activation method. The samples were first irradiated in the TRIGA MARK II reactor for 3.5 hrs. The samples were analyzed with an automatic gammaspectrometric instrument. The precision limit of the method is ±10%.

Table 2 shows the results of the test. Xylan was the reference sample with no crosslinks. We can see when comparing the starting material HPX-A to the crosslinked HPX-A, there is a decrease in the amount of double bonds (from 13.7 wt-% to 11.3 wt-%) which indicates that 18% of double bonds have reacted. The same can be observed for the other starting material HPX-BA and the crosslinked HPX-BA (from 6.5 wt-% to 4.4 wt-%), where 32% of double bonds have reacted. This proves that the rest of unreacted double bonds are available for further modification or grafting reaction.

TABLE 2
Crosslinking efficiency of allylic double bonds calculated from
the amounts of bromine found with instrumental neutron
activation method

| | Sample | Br (w/w) |
|---|---|---|
| 1 | Xylan | 0.04 wt-% |
| 2 | HPX-A | 13.7 wt-% |
| 3 | HPX-BA | 6.5 wt-% |
| 4 | Crosslinked HPX-A | 11.3 wt-% |
| 5 | Crosslinked HPX-BA | 4.4 wt-% |

### Morphological Characterization: Scanning Electron Microscopy (SEM).

The hydrogels were morphologically characterized by SEM to investigate the structural differences between the gels with and without crosslinker. The hydrogel samples were immersed in liquid nitrogen and freeze-dried before the SEM analysis. The gels without crosslinker have a more irregular structure than the gels with crosslinker that have a very uniform pore structure.

### Swelling Measurements.

Swelling measurements were performed for all synthesized gels placing the dried gels in an excess of deionized water at room temperature. A typical swelling curve is shown in

Figure H for HPX-BA, HPX-A and X-BA crosslinked with 1 and 5 mass-% of DAG crosslinker. The curves show that the water absorption property is highest for HPX-A and the lowest for X-BA. It could be expected that the gels made with xylan derived polymer with ds=0.2 (HPX-BA) would absorb the most but in this case they don't. This is probably due to the presence of butyl groups that make the polymer more hydrophobic. The amount of crosslinker (1 or 5 mass-%) doesn't have a big influence on the water absorbency. Figure I clearly shows the differences in absorbencies between the xylan derived polymers (HPX-BA, HPX-A and X-BA) without crosslinkers. When comparing Figure H with Figure I we can also see that the presence of the crosslinker doesn't affect the water absorbency significantly.

### Mechanical Testing.

Samples for mechanical testing were prepared in cylindrical form with a thickness of 10 mm and a diameter of 36 mm. The swollen gel samples were placed between two metal cylinders and evaluated in a uniaxial compression experiment with an Instron 5500R Universal Tensile Tester. The samples were compressed 1 mm/min. We can see clearly from Figure J that HPX-A with 5 wt-% crosslinker can bear a 100 N load whereas HPX-BA with 5 wt-% crosslinker can bear only about 50 N. The same can be seen from figure Figure K where HPX-BA and HPX-A with no crosslinker have been compared.

### Materials

The following reagents were used as received: (+)-N,N′-diallyltartardiamide (99+%, Aldrich), D-(+)-xylose (≧99%, Sigma-Aldrich), L-(+)-arabinose (99%, Sigma), galactaric acid (mucic acid, 97%, Aldrich), allylamine (≧98.0%, Fluka), tetrahydrofuran (99.9%, Aldrich), methanol (HPLC grade, Rathburn), ethanol (Altia), sulphuric acid (95-97%, Fluka), nitric acid (≧65%, Fluka), 2-propanol (HPLC grade, Rathburn), allyl glycidyl ether (≧99%, Sigma-Aldrich), butyl glycidyl ether (95% Aldrich). Hydroxypropylated xylan was prepared elsewhere according to literature.^{xxii} The following starting materials were synthesized according to literature procedures: Dimethylgalactarate, dimethylxylarate and dimethylarabinarate,^{xx} and xylaric and arabinaric acid.^{xix} The crosslinkers were prepared according to Anker.^{xiv} Never-dried (5-10 wt-%, containing 0.9% NaOH) or dried xylans extracted, for example, from (bleached) birch pulp were used as starting materials.

### Methods

¹H and ¹³C-NMR spectra were recorded on a Varian Mercury VX (300 MHz) spectrometer or on a Bruker Avance III (500 MHz) spectrometer in DMSO or D2O. Melting points (mp) were determined in open capillaries using SANYO Gallenkamp melting point apparatus. TLC was performed on Silica Gel 60 F₂₅₄ (E. Merck) with detection by UV light or charring with H₂SO₄. Elemental analyses were performed on Elementar Analysensysteme GmbH Variomax CHN analyzer. IR spectra were recorded on a Bruker Equinox 55 FTIR spectrometer. Mass spectra were recorded using direct infusion ESI technique on MicroMass Quattro II Spectrometer. A F300S UV system (Fusion UV Systems, Inc.) was used for the irradiation of the hydrogel samples. The UV system consists of a P300MT power supply and an I300MB irradiator which emits UV light in a range from 200 to 400 nm. The structures of the swollen gels were characterized by scanning electron microscopy (SEM, LEO DSM 982 Gemini FEG-SEM).

### Synthesis of the Monomers

N,N′-diallylarabinardiamide. L-(+)-Arabinose was oxidized^{xix} to L-(+)-arabinaric acid with concentrated HNO₃ and subsequently esterified^{xx} with methanol according to Kiely et al. The resulting syrupy dimethylarabinarate (21.9 g, 0.105 mol) was dissolved under argon in dry tetrahydrofuran (210 mL) in 500 mL glass flask. Allylamine (24.5 mL, 0.326 mol) was added and the temperature was raised to +70° C. After 22 h the solution was cooled and the crystals were filtered and washed with THF/10% ethanol-solution (110 mL).

Light yellow crystals were obtained, yield 8.6 g (32%): m.p. 180-185° C.; IR: v 3280 (amide I), 3082 (CH═), 1638 (CO), 1553 (amide II), 1045 (OH) cm⁻¹. ¹H NMR (Me₂SO-d₆, 300 MHz): δ 8.10 (t, 1H, NH, J=11.4 Hz, J=6.0 Hz), 7.76 (t, 1H, NH, J=6.1 Hz, J=12.5 Hz), 5.82 (m, 2H, allyl=CH, J=1.8 Hz), 5.62 (d, 2H, OH-2/4, J=6.2 Hz), 5.12 (m, 4H, allyl CH₂=, J=1.8 Hz), 4.77 (d, 1H, OH-3, J=6.3 Hz), 4.15 (dd, 2H, H-3, J=1.5 Hz, J=6.1 Hz), 3.95 (m, 2H, H-2/4, J=1.5 Hz, J=6.3 Hz), 3.77 (t, 4H, —CH₂—NH, J=5.5 Hz); ¹³C NMR (Me₂SO-d₆, 75 MHz): 174.2, 173.3 (CONH), 136.3, 136.0 (—CH═CH₂), 116.0, 115.8 (—CH═CH₂), 73.9 (C-3), 72.4, 72.3 (C-2 ja C-4), 41.6 (CH₂—NH); MS (ESI): [M+H]⁺ found 259; requires 259.282. Anal. Calcd for C₁₁H₁₈O₅N₂: C, 51.15; H, 7.03; N, 10.85. Found: C, 40.42; H, 5.69; N, 8.08.

N,N′-diallylxylardiamide. The starting material dimethylxylarate was prepared from D-(+)-xylose as described for 3.2.1. Dimethylxylarate (15.0 g, 71.9 mmol) was dissolved under argon in dry tetrahydrofuran (150 mL) in 250 mL glass flask. Allylamine (16.2 mL, 215.6 mmol) was added and the temperature was raised to +70 degrees Celsius. After 24 h the solution was cooled and the crystals were filtered and washed with THF/10% ethanol-solution (80 mL).

Light yellow crystals were recrystallised from ethanol, yield 7.0 g (37%): m.p. 181-185° C. (lit.: 166-170° C.).^{xv} IR: v 3417 (amide I), 3080 (CH═), 1638 (CO), 1546 (amide II), 1125 (OH) cm⁻¹. ¹H NMR (Me₂SO-d₆, 300 MHz): δ 7.83 (t, 2H, NH, J=5.9 Hz, J=11.9), 5.84 (m, 2H, allyl=CH, J=1.8 Hz), 5.50 (d, 2H, OH-2/4, J=5.7 Hz), 5.13 (m, 4H, allyl CH₂=, J=1.8 Hz), 4.81 (d, 1H, OH-3, J=7.3 Hz), 4.11 (dd, 2H, H-2/4, J=5.7 Hz, J=4.1 Hz), 3.95 (m, 1H, H-3, J=7.3 Hz, J=4.1 Hz), 3.76 (m, 4H, —CH₂—NH, J=5.9 Hz); ¹³C NMR (Me₂SO-d₆, 75 MHz): 173.3 (CONH), 136.2 (—CH═CH₂), 115.9 (—CH═CH₂), 73.5 (C-2 ja C-4), 72.9 (C3), 41.6 (CH₂—NH); MS (ESI): [M+H]⁺ found 259; requires 259.282. Anal. Calcd for C₁₁H₁₈O₅N₂: C, 51.15; H, 7.03; N, 10.85. Found: C, 46.28; H, 6.38; N, 9.52.

N,N′-diallylgalactardiamide. Galactaric acid was esterified with methanol according to Kiely et al.^{xx} Dimethylgalactarate (26.5 g, 111.3 mmol) was dispersed in dry tetrahydrofuran (400 mL) under argon in 1 litre glass reactor. Allylamine (25.1 mL, 334 mmol) was added and the temperature was raised to +70 degrees Celsius. After 48 h the solution was cooled and the crystals filtered and washed with THF/10% ethanol-solution (300 mL). Recrystallisation from water gave pure white crystals, yield 19.1 g (59%): m.p. 215-220° C. (lit. 207-210° C.)^{xv}; IR: v 3290 (amide I), 3084 (CH═), 1634 (CO), 1537 (amide II), 1047 (OH) cm⁻¹. ¹H NMR (Me₂SO-d₆, 300 MHz): δ 7.73 (t, 2H, —NH, J=12.1 Hz, J=6.0 Hz), 5.84 (m, 2H, allyl=CH, J=5.1 Hz, J=10.2 Hz) 5.28 (d, 2H, OH-2/5, J=7.1 Hz), 5.14 (m, 4H, allyl CH₂=, J=5.1, J=10.3), 4.45 (dd, 2H, OH-3/4, J=2.5, J=8.6), 4.2 (d, 2H, C-2/5, J=7.1), 3.84 (dd, 2 H, C-3/4, J=2.1, J=8.6), 3.78 (t, 4H, —CH₂—NH, J=5.5, J=11.0 Hz); ¹³C NMR (Me₂SO-d₆, 75 MHz): 174.2 (CONH), 136.3 (—CH═CH₂), 115.8 (—CH═CH₂), 71.7 (C-2/3/4/5), 41.6 (CH₂—NH); MS (ESI): [M+H]⁺ found 289; requires 289.308. Anal. Calcd for C₁₂H₂₀O₆N₂: C, 49.99; H, 6.99; N, 9.72. Found: C, 49.85; H, 6.93; N, 9.71.

### Xylan Derivatisation

Hydroxypropylated xylan. Non-dried (5-10 wt-%, containing 0.9% NaOH) or dried xylans extracted, for example, from (bleached) birch pulp were used as starting materials. The pH and/or sodium hydroxide content was adjusted to pH 11-13 and/or 0.5-2.0 M. The mixture was first stirred for 1 h at 60° C. and then 24 h at room temperature. Propylene oxide was added into the reaction mixture and left to react for 24 h. After the reaction the pH was adjusted to 6-7 with ˜6 M HCl. Xylan derivatives were first precipitated using acetone (5 times volume compared to the amount of water in the reaction mixture) and purified by dialysis for two nights, first night in running tap water and the second night in standing deionized water (suitable membrane cut-off was 5000 Daltons), concentrated, and finally freeze-dried.

Derivatization of Hydroxypropylated Xylan with Butyl and Allyl Glycidyl Ether.

600 mL (627 g, 11.43 mass-% solids) of hydroxypropylated xylan solution was placed in a 1-liter reactor with a mechanical stirrer. The sodium hydroxide content of the solution was adjusted to 1.0 M. The mixture was first stirred for 1 h at 65° C. and then 24 h at room temperature. The brown solution was heated to 45° C. under argon. Butyl glycidyl ether (64.5 mL) and allyl glycidyl ether (28.7 mL) were mixed and added drop wise into the reaction mixture and left to react for 24 h in 45° C. The solution turned white and turbid. After cooling the reaction mixture turned into a brown solution and the pH was adjusted to 6-7 with ˜6 M HCl. The product was first precipitated with 4 litres of acetone, left to settle overnight and washed with 2×1 litres of acetone. Excess acetone was decanted and the precipitate left to dry in air overnight. The product was dissolved in 250 mL of water and purified by dialysis for two nights, first night in running tap water and the second night in standing deionized water (suitable membrane cut-off was 5000 Daltons) and finally freeze-dried to obtain 26.9 g of white crystalline solid. More product was obtained by evaporating the acetone from the supernatant remaining from the precipitation step. A slimy residue was obtained after pouring out the excess water. The residue was diluted with a small amount of ethanol, and dialysed and freeze-dried as previously described to obtain 32.9 g of pure product. Overall yield 59.8 g.

Derivatization of Hydroxypropylated Xylan with Allyl Glycidyl Ether.

The reaction was performed as in 3.4.2 but t-BuOH (364 mL) was added as a co-solvent to the reaction mixture and only allyl glycidyl ether (77 mL) was used. The entire product was obtained from the precipitation step. Yield 47.44 g.

### Preparation of Hydrogels

To a solution of 2.0 g of xylan derivative and 1 or 5 mass-% of crosslinker in 20 mL of deionized water, 5 mass-% of radical initiator potassium persulfate was added. The solution was poured on a Petri dish, placed in an UV oven and polymerized under UV light for 3 to 4 minutes. After crosslinking the gels were washed several times with deionized water to remove any unreacted material and salts. The gels were dried in a vacuum oven in +40° C. for 48 h or by freeze-drying. Before freeze-drying the wet gels were immersed in liquid nitrogen.

### Swelling Assessments

For swelling measurements, the gel samples were dried to a constant weight in 40° C. in a vacuum oven (m_{dry}) and immersed in excess of deionised water at room temperature. Excess water was removed with a dry filter paper and the sample (m_{wet}) weighed at time intervals. The degree of swelling was determined by the following equation:

$$Degree of swelling = \frac{{m}_{wet} - {m}_{dry}}{{m}_{dry}} * 100 \%$$

### Coatings, Primers, Binding Agents and Films for Coating Applications:

A typical example from the use of coupling substituent is grafting a polymer chain on polysaccharide for forming copolymers. The starting point of this grafting reaction for building a polymer chain thereon, is a suitable coupling substituent of said polysaccharide. This substituent contains a functional group with suitable unsaturation such as a reactive double bond (allyl, vinyl, acryl) or an epoxy group in case of a ring opening polymerization. The polysaccharide can also be coupled from these coupling substituents to another polymer for making copolymers. In the same time said polysaccharide can be subjected crosslinking with said other polymer from numerous coupling substituents when coupling substituents in different polymers are reacted with each other.

Also the method for preparing products for different coating applications begins by introducing into numerous free hydroxyl groups of cellulose or hemicellulose polymer numerous reactive substituents (coupling substituents). This can be done according to methods presented in general scheme II (above) by etherifying some or all hydroxyl groups of said cellulose or hemicellulose polymer. The modifying of free hydroxyl groups of cellulose or hemicellulose polymer produces a multireactive cellulose or hemicellulose ether compound consisting numerous reactive coupling substituents which, may be proceed according to process c-e using reactions (1)-(4) as follows:

(c) modified cellulose or hemicellulose molecules provided with numerous coupling substituents are attached onto a material matrix. Attaching may be done from the coupling substituents but it can also be based on other kind of bonding between material matrix and said modified cellulose or hemicellulose compounds. If attaching is done by coupling polymer matrix with the reactive coupling substituents of said modified cellulose or hemicellulose, it is made according to general reaction scheme (4)

AC-(R₁)ₙ+xpoly(M)->AC-(R₁)ₙ₋ₓ-co-poly(M) (4).

When said modified cellulose or hemicellulose molecules provided with numerous coupling substituents have been fixed onto the polymer matrix, such as polymer substrate, these modified and fixed cellulose or hemicellulose molecules may be further modified by crosslinking them with each other using process step d:

d) crosslinking said cellulose or hemicellulose polymer chains (A) and (B) with each other according to reaction scheme (1)

AS₁-(R₁)ₙ+(R₂)ₘ-BS₂->(AS₁-(R₁-R₂)ₙ₊ₘ₋₂ₓ-BS₂) (1)

wherein A, B, R₁ or R₂, S₁, S₂, n, m and x are as defined above.

Onto said modified cellulose or hemicellulose molecules may be also grafted another polymer with monomer (M). This polymer is grafted onto the coupling substituents of said modified cellulose or hemicellulose molecules using process step e:

e) grafting said cellulose or hemicellulose polymer chains (A) and (B) with a monomer M according to general reaction scheme (3):

AC-(R₁)ₙ+xM->AC-(R₁)ₙ₋ₓ-co-poly(M) (3)

wherein
provided with numerous coupling substituents A, B, R₁ or R₂, S₁, S₂, n, x and M and poly (M) are as defined above.

Different coating product can be produced using method with process steps c-e.

In one embodiment of the invention the cellulose based filter material is modified using said modified cellulose or hemicellulose compounds with numerous coupling substituents as primers. The coupling is done according to reaction scheme (4). Thereafter these cellulose or hemicellulose compounds with numerous coupling substituents can be grafted with polymers having stimuli-responsive properties using reaction scheme (3).

Stimuli-responsive polymers means herein, that the polymer changes its physicochemical properties in response to changes in its environment. Polymer may change its physicochemical properties in response to pH, temperature, ionic strength, light, electric and magnetic fields and chemicals cues (Wandera et al.).

In another embodiment of the invention the filter material is modified by attaching said modified cellulose or hemicellulose compounds to this filter material with other kind of mechanism than covalent bonding. Thereafter these cellulose or hemicellulose compounds with numerous coupling substituents can be grafted with polymers having stimuli-responsive properties using reaction scheme (3).

In another embodiment of the invention fiber material is modified using said modified cellulose or hemicellulose compounds with numerous coupling substituents as primers. The coupling is done according to reaction scheme (4). Thereafter modified cellulose or hemicellulose compounds with numerous coupling substituents are grafted with polymer(s) using coupling substituents.

In another embodiment of the invention modified cellulose or hemicellulose compounds with numerous coupling substituents is used as binding agent for a coating agent or as coating to be applied onto a surface of paper web. The internal crosslinking of the binding agent proceeds according to reaction scheme (1) but it may happen later, for example when the coating undergo heating during paper web calendaring.

### EXAMPLES

Producing multireactive polysaccharide compounds with numerous coupling substituents.

### Example A

### Preparation of Modified Cellulosic Fibres and Xylans by a Reactive Extraction Process Using Alkyleneoxides or their Ethers

Bleached birch pulp fibres (or pine, eucalyptus, spruce) were treated in alkaline conditions with some etherification reagents for hydrophobisation and at the same time for removing excess of hemicelluloses. 0.5 kg of birch pulp containing 29.1 wt-% (145 g) of fibres was added into a 15 L reaction vessel with 1.5 L of 90% aqueous t-butanol. 114 ml of 10 M NaOH and 600 ml of water were added. The reaction mixture was stirred overnight at room temperature. The reaction mixture was then heated up to 60° C. and 250 ml of butyl glycidyl ether together with 100 ml of allyl glycidyl ether were added slowly into the reaction vessel. This mixture was stirred overnight at 60° C. pH of the reaction mixture was adjusted to neutral with sulphuric acid. The reaction mixture was filtered, washed with 5 L of 50% aqueous ethanol, then three times with water (3×5 L), and finally with 5 L of 20% aqueous ethanol. Approximately 40% of hemicelluloses were removed and at the same time the fibres were slightly modified with butyl and allyl functionalities (overall DS approx. 0.01, measured by ¹³C CP/MAS NMR, see Figure X). If needed, these chemically pretreated fibres were microfibrillated, for example, using so-called Masuko refiner (5 fibrillation cycles) to a xylan-poor MFC (xpMFC) quality fibres with a dry matter content approx. 2-5%.

If hemicellulose containing cellulose fibres were used as starting materials, the filtrate and the first washing fraction (50% aq. ethanol) were combined and evaporated to a syrup containing by-products (derivatized hemicelluloses such as xylans, oligomeric by-products of epoxy reagents, salts etc.). The by-products and salts were removed from filtrates by ultra filtration. The product mixture was concentrated and finally freeze-dried yielding white or slightly yellowish powder (see FIG. 1).

### Example B

### Modification of Hemi-Free Cellulose Pulp Using Alkyleneoxides or their Ethers

Preparation of 1-allyloxy-2-hydroxy-propyl Derivatives of Cellulose with Different DSs:

35.5 g of the cellulose pulp (such as dissolving cellulose without hemicelluloses) containing both 10 g of a cellulose (AGU) were weighted into two 1000 ml of reaction vessels. 150 ml of water, 21.3 ml of 10 M NaOH, and 180 ml of 90% aqueous tert-butanol were added into the vessels. The reaction mixtures were stirred for 2 hrs at 65° C. and cooled down to 45° C. Respectively, 17.8 and 31.3 ml of allyl glycidyl ether (A) was added into the vessels and the reaction mixtures were stirred overnight at 45° C. The molar ratios of the reagents were respectively, AG U/NaOH/A, 1/3.4/2 for a theoretical DS_{A} 2.0 and 1/3.4/3.5 for a theoretical DS_{A} 3.5. The samples were filtrated and washed with 300 ml of ethanol, 300 ml of water-ethanol (1:1), and 300 ml of water, and finally with 300 ml of 20% aqueous ethanol. Part of the samples were freeze-dried to 1-2 g of white fibrous materials for analytical purposes. The DS results were determinated by 13C CP/MAS solid phase NMR, see FIG. 2. For example, the integral of C1 was set to 1, the summarized integral of the peaks C11-C13 from the butyl side chain of a sample was 0, 1353DS can be calculated easily from the equation presented below:)

### Example C

### Modification of (Nano/Micro)Fibrillated Cellulose Fibres Using Alkyloxides or their Ethers

The xpMFC prepared using the reactive extraction method (see Example A) was solvent-exchanged to acetone for reducing the amount of water in the allylation step. Water competes with cellulosic hydroxyl groups in the nucleophilic substitution reaction to epoxy groups of glycidyl reagents, and it is important to reduce the amount of water as much as possible.

### Solvent Exchange to Acetone:

2 L of acetone was mixed with 2 L of the (fluidized, 2%, 40 g of dry weight) xpMFC, and it was settled overnight. This mixture was centrifugated (20 min, 4750 rpm). The xpMFC was again suspended to the volume of 2.8 L with acetone, and mixed carefully. The centrifugation was repeated. The xpMFC was again suspended to 2.8 L with acetone, and mixed carefully. The centrifugation was repeated. The dry matter content of solvent-exchanged xpMFC after these steps was 6.01% (665 g of total weight). Water content approx. 2-5%.

### Allylation Procedure:

165 g (containing 9.9 g of fibres, water approx. 3-8 g) of xpMFC quality (solvent exchanged to acetone), 18.5 ml of 10 M NaOH (3 mol-ekv/1 mol AGU), 0-100 ml of water, and 100-300 ml of 90% aqueous t-butanol were added into a 1 L reaction vessel. The reaction mixture was stirred overnight at rt. The reaction mixture was then heated to 65° C. Allyl glycidyl ether (3 mol-ekv./1 mol AGU) was added slowly and stirred again overnight at 65° C. pH was adjusted to neutral with sulphuric acid, fibres were washed first with 96% aqueous ethanol, then with 50% aqueous ethanol, twice with water, and finally washed twice with 20% ethanol using centrifugation between washing steps. The degree of substitution was 0.066 for allyl groups determinated by ¹³C CP/MAS NMR, see also FIG. 2. The result was also verified using a method published by Heinze et al. (2008) where allyl groups were first brominated and then the bromine content was determinated. In this case the bromine content was analyzed using a so-called instrumental neutron-activation method. The samples were first irradiated in the TRIGA MARK II reactor for 4.5 hrs. The samples were then analyzed with an automatic gamma spectrometric instrument. The precision limit of the method is ±10%. The result was using the bromination method DSₐₗₗ=0.055 (bromine content 5.0 wt-%).

### Example D

### Derivatization of Xylans Using Alkyloxides or their Ethers

Non-dried (5-10 wt-%, containing 0.9% NaOH) or dried xylans extracted, for example, from (bleached) birch pulp were used here as starting materials. The pH and/or sodium hydroxide content was adjusted to pH 11-13 and/or 0.5-2.0 M. The mixture was stirred for 2-24 h at 20-60° C. The derivatizing reagents such as propylene oxide, allyl glycidyl or butyl glycidyl ethers were used. The derivatizing reagent(s) was added into the reaction mixture (either separately step by step or together if several reagents were used at the same time) in a certain molar ratio, and a reaction mixture was let to react for 2-24 h between additions. Two derivatizing reagents can be added together in a certain ratio but reaction can be also performed step by step addition of one reagent before the next one. After the reaction the pH was adjusted to 7-8 with an acid (sulphuric acid or HCl). Xylan derivatives were usually first precipitated using acetone (5 times volume compared to the amount of water in the reaction mixture) and/or purified by ultrafiltration techniques (suitable membrane cut-off was 3500-5000 Daltons), concentrated, and finally freeze-dried.

### Example E

### Derivatization of Hydroxypropyl or Hydroxyethyl Celluloses Using Alkyleneoxidies or their Ethers

Commercial hydroxypropyl or hydroxyethyl celluloses (HPC or HEC) were used as starting materials. For example, hydroxypropyl cellulose (Sigma-Aldrich, 435007, average M_{W} 80000) was etherified using aqueous alkaline reaction conditions. HPC was treated in 0.5-2.0 M of a base such as sodium hydroxide, for 2-24 hrs, at 20-60° C. with glycidyl alkyl/allyl ether or in dry organic reaction conditions with alkyl halide reagents using, for example, sodium hydroxide or potassium-t-butoxide as catalysts with different kind of alkyl chain length (C₂-C₁₈) and/or with double or triple bond functionalities yielding crosslinkable or otherwise functional derivatives, with adjusted degree of substitution (usually between DS 0.05-1.0). The unsaturated bonds may be used for further derivatisation such as epoxidation, for example, using hydrogen peroxide, alkyl peroxides, or peracids as epoxidating reagents, or for grafting reactions with suitable monomers yielding side-chains from a cellulose backbone with tailored properties such as stimuli-responsive behaviour (see FIG. 2, see also example B).

### Example F

### Preparation of Epoxy Functionalized Microfibrillated Cellulose

Allylated xpMFC (xpMFC-A) was centrifugated first to a dry matter content 4.74% before epoxydation step. The epoxydation of xpMFC-A was performed using the procedure published by Huijbrects et al. (2010). 42 g of MFC (ds. 4.74%, containing 2 g of fibres), 35 ml of buffer solution (1.75 mg/0.017 mmol of Na₂CO₃, and 350 mg/4.17 mmol of NaHCO₃), and 5 ml of acetonitrile were added into a reaction vessel. The mixture was stirred for a while, and then 9.4 ml (0.11 mol) of hydrogen peroxide (30% w/w solution) was added. The suspension was stirred at 30° C. overnight, and then cooled to rt. The product (xpMFC-E) was obtained by filtration, and subsequently washed with water (5×75 ml), ethanol (2×75 ml), and finally with 20% aqueous ethanol. The epoxy content was analyzed using the slightly modified method published by Huijbrects et al. (2010). 1 g of freeze-dried xpMFC-E fibres were suspended in water (9 mL), followed by addition of 10 mL of a suitable amino compound (such as butamine or 4-(para-nitrobenzyl)pyridine or crosslinking 1,6-hexanediamine or 4,4′-diaminodiphenylmethane) solution in ethanol). The suspension was stirred overnight at 30° C. The product was isolated by centrifugation (4750 rpm/15 min), washing with ethanol (2×10 mL) and several times with water. The result DSₑₚₒₓ=0.061 was calculated from the amount of nitrogen (0.9 wt-% of nitrogen) analyzed by Kjeldahl method. The result showed that the allyl groups were converted to epoxy groups almost quantitatively.

The invention is illustrated further with non-restricting examples.

### Films and Coatings Applications and Membrane-Like Materials

Polysaccharide based films and membranes can be prepared by using and/or combining several type of starting materials such as polysaccharide derivatives with alkyl, alkenyl, etc. functionalities used to adjust the properties of these starting materials for certain type of coupling or crosslinking chemistry and application or purposes. The substituent can be bonded to a polysaccharide chain with ester or ether bonds. Allyl or acrylate groups are used for crosslinking, coupling, grafting reaction using radical reactions, or other functionalities such as epoxy groups are used for coupling these derivatives with suitable additional crosslinking substituents such as small molecular or macromolecular crosslinkers having, for example, at least two amino, carboxylic acid, hydroxyl groups in their molecule such as polyvinyl alcohol.

A polysaccharide derivative containing more than 5-10 double bonds such as allyl derivative of hydroxypropyl cellulose or allyl derivative of xylan, with or without modified cellulose fibre, and with or without additional commercially available additional crosslinking monomers substituted or grafted into said double bond containing substituents such as methylenebisacrylamide (MBA) or monomers based on aldaric acid such as N,N′-diallylaldardiamide, were dissolved in water, or aqueous organic solvent mixtures, or other solvent mixtures to a 1-20% solution or suspension together with a suitable (UV) radical initiator such as ammonium persulphate, potassium persulphate or benzophenone. The solution or suspension was poured on a Petri dish and placed in 60° C. for 2-24 h (free films), or the solution or suspension was spread using different techniques onto a matrix material which can be, for example, a paper board, plywood etc (coatings). More radical initiator was sometimes added and the wetted films were treated by an UV light. The films were dried yielding free plastic-like films or yielding (crosslinked) polysaccharide layer on a matrix material. Some more detailed examples 1-3 are given here.

### Example 1

### Preparation of Transparent and Flexible Xylan Based Films

The films were prepared by dissolving 1.51 g of a xylan derivative into 50 ml of water at rt, and then by casting that solution onto a petri-dish (diameter 135 mm). A solution was let to dry at rt overnight or more. All the etherified xylan derivatives formed transparent and flexible films using a casting method. For example, a film (thickness 0.12 mm) prepared from the X-BA derivative was mechanically the strongest one within all the xylan derivatives: Tensile strength was 44 MPa (highest value), Elongation at break 22% (highest value), and Young's Modulus was 524 MPa (moderate). The thickness of prepared films for applications tests were usually 120 m. The moisture sensitivity of films was also investigated and the results are presented in FIG. 3, and barrier properties in Table 3.

TABLE 3
Mechanical properties of some xylan films.

| | | Tensile | Elongation at | Young's |
|---|---|---|---|---|
| | | strength | break | Modulus |
| Sample | DS (HP/B/A) | (MPa) | (%) | (MPa) |
| X(7) | unmodified xylan, | nm | nm | nm |
| | no film | | | |
| HPX | 1.60/0/0 | 42 | 6 | 1110 |
| HPX(6)-BA | 0.63/0.34/0.17 | 5 | 6 | 123 |
| HPX-A | 0.85/0/0.36 | 19 | | 914 |
| X-B | 0/2.1/0 | yes | | |
| X(4)-BA | 0/0.75/0.38 | 44 | 22 | 523 |

HP = hydroxypropyl,
B = 1-butoxy-2-hydroxy-propyl,
A = 1-allyloxy-2-hydroxy-propyl substituents.

### Hydrogels and Soft Membranes

### Example 2

### Preparation of Hydrogels: Crosslinking Efficiency

The cross-linking was done in a 2-10% water solution (e.g. allylated xylans) or suspension (e.g. microfibrillated and allylated cellulose fibres). A suitable radical initiator, e.g. potassium or ammonium persulphate (KPS or APS) was added. The reaction was performed at 60-70° C. for 2-4 hours or using UV-light to initiate a radical reaction. If UV-irradiation was used a sample was usually irradiated for 1-5 min for completing a crosslinking reaction. A more detailed data of two examples is presented in Table 1. An example of typical hydrogel and its structure after freeze-drying is presented in Figure X. The degree of substitutions (DS_{A}) for allyl (A) substituents—the amount of double bonds—before and after crosslinking reactions were determinated using a bromination of allylic double bond with bromine [Wenz et al. 1999]. The bromine content was analyzed using a so-called instrumental neutron-activation method. The samples were first irradiated in the TRIGA MARK II reactor for 4.5 hrs. The samples were then analyzed with an automatic gamma spectrometric instrument. The precision limit of the method is ±10%. The crosslinking efficiency—the amount of reacted double bonds—is presented in Table 4.

TABLE 4
Inter and intramolecular crosslinking efficiency of allyl functionalities.

| | | | | Concentration | |
|---|---|---|---|---|---|
| | | Crosslinking | | of a polysaccharide | Reaction |
| Polysaccharide | | efficiency | Crosslinking | in a reaction | time |
| derivative | DS_{A} | (%) | method | (wt-%) | (min) |
| Allylated xylan | 0.40 | 50 | KPS/UV | 10 | 2 |
| (X-BA) | | | | | |
| Allylated | 0.06 | 62 | APS/60° C. | 1 | 120 |
| microfibrillated | | | | | |
| cellulose fibre | | | | | |

### Example 3

### Preparation of Hydrogels Using Additional Crosslinking Agents

The properties of hydrogels can be also tailored using crosslinkers or by grafting. Here, N,N′-diallylaldardiamides (DA) such as a commercial N,N′-diallyltartaramide or N,N′-bismethyleneacrylamide (MBA), or novel crosslinkers synthesized here (see example X) which are derivatives of aldaric acids such as N,N′-diallylamide derivatives of arabinaric, xylaric, galacturonic acids have been used as additional small-molecular crosslinkers for modification of properties of hydrogels. The crosslinking reactions are performed as in Example 5 but additionally 1-10 wt-% of a N,N′-dialllyaldardiamide was added into a reaction mixture. The amount of DA crosslinkers in a hydrogel network was analyzed after freeze-drying using the Kjeldahl method for a determination of the amount of total nitrogen in hydrogel samples. The results for different kind of DA crosslinkers are presented in table 1. The amounts of DA crosslinkers in the hydrogel networks varied between 1.5 to 3.9 wt-% depending on the xylan derivative and DA crosslinkers themselves.

### Example 4

### Preparation of Cellulose-Based Hydrogels

Allylated cellulose fibres (pulp, microfibrillated or nanofibrillated) can be used as is as starting materials for a preparation of hydrogels or soft membranes. They can be also grafted with suitable monomers, for example, increasing the swelling ratio/water uptake of these materials.

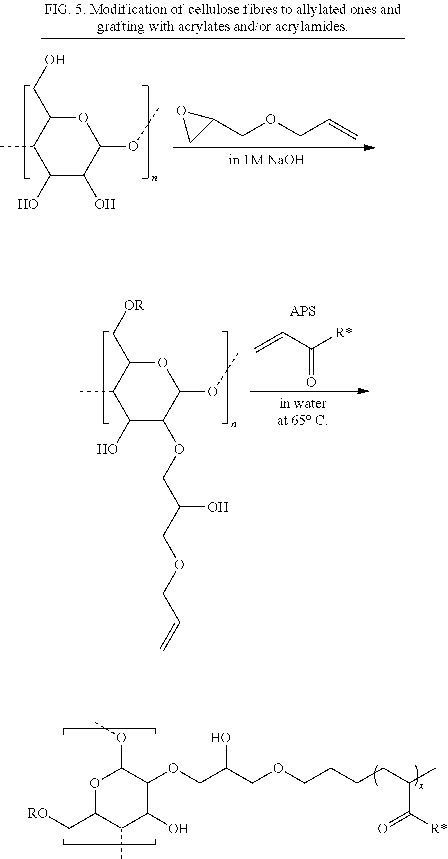

The adsorbents were prepared using the allyl-modified cellulose fibres (prepared, for example, from dissolving pulp) as starting materials, see FIG. 5. The fibres were grafted using the monomers such as 2-hydroxyethyl methacrylate (HEMA), acrylic acid (AA), N-isopropylacrylamide (NIPAM), hydroxymethylacrylamide (HMAA) and crosslinkers such as ethyleneglycol dimethacrylate (EGDMA). The grafting reactions were performed in aqueous reaction conditions using approx. 1 g (0.05-0.06 mol) of a cellulose and 1-2 g (0.1-0.12 mol) of monomer(s) (molar ration of monomer/AGU was always 2), and in some cases also using additional crosslinkers, and ammoniumpersulphate (APS) as the radical initiator. Total volume of the reaction mixture was about 30 ml. The reactions were performed at 65° C. for 24 hrs. The hydrogel-like samples were washed several times with water for removing unreacted monomers and loose homopolymers, and finally freeze-dried—in most cases—to rigid adsorbent materials. The swelling ratios (SW) were determinated using a gravimetric method.

The swelling ratios varied approx. from 5 (500%) to 14 (1400%) grams of water/gram of an adsorbent material. The target was to have at minimum of 400-500% water uptake. This target was already reached but the final target will be to increase the SWs up to 20-50 g/g. The swelling ratios are presented in Table 2. The conversions (yield) of the starting materials were very good with all of the prepared adsorbents, 80-100%. This indicates a very effective crosslinking and grafting reactions, or a very high incorporation of acrylate and acrylamide polymers into the three dimensional structure of a hydrogel/adsorbent. For example, the nitrogen content of the sample ACe-graft-PHMAA was also determinated using the Kjeldahl method yielding 7.3 wt-% of nitrogen. The amount of PHMAA was calculated to be 53 wt-% and allylated cellulose (Ace) to be 47%, respectively 55 and 45 wt-% in the grafting reaction. In many cases the formed structure seemed to be also mechanically rather strong, Some results are presented in Table 5.

TABLE 5
Swelling ratios and yields.

| | Molar | SW | Yield |
|---|---|---|---|
| Cellulose-copolymer(s) | ratios | (g/g) | (%) |
| ACe-graft-PHEMA | 1/2 | 5.5 | 86 |
| AC-graft-PHMAA | 1/2 | 5.5 | 106 |
| ACe-graft-PHMAA | 1/2 | 11.6 | 92 |
| AC-graft-PHEMA | 1/2 | 5.8 | 96 |
| ACe-graft-PNIPAM-co-PHMAA | 1/1/1 | 13.5 | 83 |
| AC-graft-NIPAM-co-PHMAA | 1/1/1 | 12.5 | 91 |
| ACe-graft-PNIPAM-co-PHMAA-co- | 1/1/1/0.1 | 13.6 | 81 |
| EGDMA | | | |
| AC-graft-PNIPAM-co-PHMAA-co- | 1/1/1/0.1 | 11.4 | 89 |
| EGDMA | | | |

### Example 5

### Preparation of Cellulose-Based Soft Membranes with Stimuli-Responsive Properties

Fibres were grafted at 60° C., for two hours (usually) using ammonium peroxosulphate as an initiator in aqueous conditions (suspensions) with N-isopropylacrylamide (NIPAM) and/or acrylic acid (AA), or N-vinylcaprolactam (VCL) as monomers.

20 g of 5 wt-% suspension of allylated fibres (xpMFC-A) in 20% aqueous ethanol was mixed with 63 ml of water, with 0.5 g of NIPAM or VCL in 10 ml of water, and with 0.1 g of APS in 5 ml of water. Total volume was 100 ml. A reaction mixture was poured onto a petri-dish (diameter 18 cm, glass, sealed) and kept for three hours at 60° C. A petri-dish was opened and let to dry over night at 60° C. Prepared membranes were wetted with 5 ml of APS solution (0.1 g APS in water) and exposured 3×20 sec to UV light. 50 ml of water was added to swell and unfasten membranes. Membranes started soon to come off from a petri-dish during this process. Membranes were then washed several times in turn with hot and cold water, and finally with 20% aqueous ethanol.

TABLE 6
The remaining allylic bonds after crosslinking and grafting
efficiencies with VCL monomers analyzed using the
bromination method.

| | | | DS_{A} |
|---|---|---|---|
| | Br | | (Br₂ |
| Sample | (wt.-%) | Treatments | method) |
| Unmodified cellulose fibres | 0.06 | No treatments | Nd |
| (without double bonds) | | | |
| Allylated cellulose fibres | 5.0 | No treatments | 0.055 |
| Allylated cellulose fibres | 1.9 | Crosslinked by | Nd |
| | | UV | |
| Allylated and grafted fibres with | 0.8 | Crosslinked by | Nd |
| VCL monomers | | UV | |

The crosslinking efficiency was 62 wt-%, and grafting efficiency of VCL monomers to the remaining allylic groups was 26 wt-%, see Table 6.

Allylated cellulose fibres formed hydrogel-like membranes, see FIG. 6. The xpMFC-A was also grafted with PNIPAM producing a stimuli-responsive material on a glass plate (d=18 cm). The stimuli-responsive behaviour was clearly observed when the dry membrane was treated with water. The membrane starts to come off from a petri-dish during a wetting step indicating some kind of “self-organizing” or stimuli-responsive behaviour. The thermo-responsive cellulose membrane becomes also a slightly white at 40° C. indicating the same behaviour. The washing and purification of thermoresponsive hydrogel-like membrane was very effective when hot and cold water was used by turns. The properties such stimuli-responsivity, swelling ratio, or other functionalities can be adjusted by changing a polysaccharide starting materials, modifiying polysaccharide with different kind substituent, or by grafting with suitable monomers for adjusting, for example, the reactivity, solubility, and/or hydrophilicity-hydrophobicity balance, molecular weight, or compatibility with other polymers/plastics or with other biomaterials.

The use in coating applications as binders, primers, and additives

### Example 6

### Preparation of Cellulose Based Stimuli-Responsive Filtration Materials Using Cellulose Derivatives as Macromolecular Crosslinkers

Commercial T750 filter paper was used as a starting material. 1.2 g of allylated hydroxypropyl cellulose was dissolved into 80 ml of ethyl acetate-isopropanol mixture (1:3). A piece of a commercially available T750 filter paper (20×16 cm, from Pall Corporation) was treated with 20 ml of all-HPC solution. This T750 filter paper was then dried. AII-HPC content was approx. 0.3 g on a filter paper. 3.5 g of NIPA was dissolved in 32 ml of tert-butanol-water mixture (1:1). 0.2 g of potassium persulphate in 4 ml of water was added into that solution. This solution (36 ml) was impregnated onto the filter paper sheet (20×16 cm) and put into a reaction chamber filled with a protection gas (Ar), and let to react at 60° C. for 2 hrs. The filter paper sample was washed hot and cold water several times, and finally dried. The PNIPAM-co-(all-HPC) content was 10% (w/w), with 97% of PNIPAM and 3% of all-HPC. The stimuli-responsive and filtration properties were also tested, see FIG. 7.

### Example 7

### Preparation of Cellulose Based Stimuli-Responsive Membranes

1 g of allylated cellulose fibres (microfibrillated, in 20% aqueous ethanol) was suspended into 50 ml of water (solution A). Typically, 0.1-1.0 g of an acryl amide derivative such as N-isopropyl acrylamide (NIPAM) was dissolved into 50 ml of water or aqueous organic solvent (solution B). 0.1 g of initiator, for example, APS or KPS was added in 5 ml of water (solution C). The solutions A, B, and C were combined and let to stand at 65° C. for 2 hrs in a reaction chamber such as a petri dish with a cover filled with a protection gas such as nitrogen or argon. The formed soft gel or membrane was dried overnight at 40° C. Small amount of water (10-20 ml) was added onto a dry membrane. The dry membrane starts to swell and at the same time to come away from a petri dish. The membrane was washed several times with cold and hot (60° C.) water for removing ungrafted homopolymers of PNIPAM and salts. Finally the membranes was treated with a suitable softener such as glycerol before a final drying step for getting slightly soft and flexible membranes at a dry stage.

### Preparation of Stimuli-Responsive Filter Materials Such as Filter Clothes or Filter Fabrics.

The polysaccharide derivatives with the multicrosslinking substituents having active double bonds are used as macromolecular crosslinkers and are prepared as published by Zhao et al. [2010]. These macromolecular crosslinkers are possible to be cured and fixed onto the matrix surface very easily and fast using a radical initiator, for example ammonium persulphate, and/or UV radiation. The coating method with this kind of polysaccharide derivatives can be used just for modification of surface properties such as hydrophobicity-hydrofilicity balance and may be also used for grafting reactions to yield new polymer layers onto fibrous, non-woven, or membrane type matrix materials such as polypropene (PP), polyethylene (PE), polyvinyl alcohol (PVA), polyethylene terephthalates (PET), or cellulose fibre based media with improved and tailored properties. The matrix material such as filter fabrics and membrane can be preactivated using corona, plasma, chemical treatments (for example some cerium salts such as cerium(IV)nitrate), or UV radiations.

### Example 8

### Modification of Fibrous Materials with Allylated Polysaccharide Derivatives

For example, 5 g of an allylated hydroxypropyl cellulose (all-HPC, DS of allyl group 0.2) was first dissolved in 150 ml of a diethyleneglycol monomethyl ether (DEGMME)-isopropanol (IPA) mixture (2:1). 30 ml of this mixture (containing 1 g of all-HPC) was first mixed with 0.5 g of ammonium persulphate (APS) in 3 ml of water. and then sprayed onto a PET type filter fabric material (Tamfelt S2209-L1, 20×28 cm). Filter fabric materials can be preactivated with corona or plasma treatment, if needed. In this example, the preactivation was not performed. The filter fabric was kept at 60° C. for 2 hrs in a reaction chamber filled with a protection gas (Ar). The filter fabric was washed with ethanol, dried, and weighed. The amount of all-HPC was typically approx. 1 g on a 20×28 cm of a filter fabric (approx. 61.9 g together: 1.7 wt-% on a filter material).

### Example 9

### Grafting of Pre-Treated Filter Materials with Stimuli-Responsive Polymers

Precoated (for example, precoated with 1 g of all-HPC on a 59.9 g of a filter fabric) filter materials can be further grafted, for example, with suitable monomers containing reactive double bonds for radical polymerizations. The precoated allylated polysaccharide derivatives can act as fixing agents which are able to crosslink and also react with suitable monomers. In this example a so-called stimuli-responsive polymer, poly(N-isopropylacrylamide), PNIPAM, was grafted onto a filter fabric such as the previous PET type filter fabric. For example, 2 g of N-isopropylacrylamide (NIPAM) together with 0.1 g of all-HPC as a macromolecular crosslinker were dissolved into 9 ml of DEGMME. 0.3 g of APS dissolved into 3 ml of water-IPA mixture (1:1) was added into the NIPAM/all-HPC solution. The solution was sprayed onto a 20×28 cm filter fabric (Tamfelt S2209). The filter fabric was kept at 60° C. for 2 hrs in a reaction chamber filled with a protection gas (Ar). The filter fabric was washed with ethanol, twice with hot and cold water, and then dried, and weighed. The amount of PNIPAM-co-(all-HPC) copolymer with precoated all-HPC macromolecular crosslinker was typically approx. 3 g (4.8% w/w) on a 20×28 cm of a filter fabric (approx. 63 g together) containing approximately 2 g of PNIPAM and 1 g of all-HPC on a filter material.

The total amount of a biopolymer based crosslinking and fixing agent such as all-HPC was typically 0.1-1.0% (w/w), and a polymer such as PNIPAM was typically in the range 3-20% (w/w) depending on a type of matrix material (filter fabric, membrane, filter paper etc.) and on the optimum amount of a polymer needed, for example, for an optimized permeability and flux through filter media. The polymeric coating layer was chemically and also otherwise very stabile according to the filtration tests performed in alkaline and acidic pHs, and also after tenths of temperature cycles. These tests also showed very clearly so-called thermoresponsive properties of PNIPAM polymer, see FIGS. 8 and 9. The flux at start with modified fabric is approx. 700 kg/(m²h) at 20° C. (pores decreased, polymer is in a swollen condition) and the flux is increased to 1000 kg/(m²h) above the lower critical solution temperature (LCST) of PNIPAM (LCST is around 32-34° C.). The filter fabric was then clogged with a white water from Kangas paper mill. The washing of the clogged filter farbric using a backwashing technique was not possible only at 20° C., but performing few times the washing steps also at 40° C. was very efficient without any washing chemicals. The same procedure was performed with the unmodified PET-S2209 filter fabric. This situation is illustrated in FIG. 9. The washing of clogged unmodified filter fabric was not possible at any temperature without washing chemicals.

### Composites

### Example 10

Epoxyallylated NFC in 20% aqueous ethanol was first transferred to acetone by centrifugation and changing a solvent several times to acetone. Epoxyallylated NFC (2 w-%) was then blended in solvent with PVA (polyvinyl alcohol) and then melt compounded. The mechanical properties (tensile stress, modulus) of melt compounded PVA—epoxyallylated NFC blend increased notably compared to untreated NFC. See Picture 10.

### The Following Clauses Setup Some of the Combinations of Features Envisaged by the Present Disclosure Concerning Hydrogels.

1. A method for preparation of a specific product from a polysaccharide in which at least one hydroxyl of a saccharide unit is substituted with an ether or ester moiety, characterized thereof, that
said ether or ester moiety is provided with ethenyl and/or epoxy functionality for preparing an activatable polysaccharide polymer,
the activatable polysaccharide polymer with ethenyl and/or epoxy functionality is optionally reacted with an additional coupling reagent, having at least two coupling functionality for preparing polysaccharide polymer with additional activatable crosslinker,
the activatable polysaccharide polymer or the polysaccharide polymer with an additional activatable crosslinker, is activated for crosslinking said polysaccharide polymer with another polysaccharide polymer by reacting said activatable polysaccharide polymer or polysaccharide polymer with an additional activatable crosslinker with a crosslinking iniator for crosslinking the polysaccharide polymer chains with each other, for preparing a product such as hydrogel, film, coating or membrane with polysaccharide backbone.
   2. A method for preparation of a hydrogel from a xylan polysaccharide in which at least one hydroxyl of a pyranose unit is substituted with an ether or ester moiety, characterized thereof, that
said ether or ester moiety is further reacted with a reagent, which has an ethenyl and/or epoxy functionality for preparing an activatable xylan polymer,
the activatable xylan polymer with ethenyl and/or epoxy functionality is optionally reacted with an additional coupling reagent, having at least two coupling functionality for preparing xylan polymer with an additional activatable crosslinker,
the activatable xylan polymer or xylan polymer with an additional activatable crosslinker, is activated for crosslinking by reacting said activatable xylan polymer or xylan polymer with an additional activatable crosslinker with a iniator for crosslinking the xylan polymer chains with each other, for preparing a hydrogel with a xylan backbone.
   3. The method according to clause 1 or 2, characterized thereof, that the polysaccharide is substituted with a lower alkyl hydroxyether before reacting with a reagent having an ethenyl or an epoxy functionality.
   4. The method according to any one of the previous clauses, characterized thereof that the reagent with the ethenyl or epoxy functionality contains an allyl or an epoxy residue.
   5. The method according to clause 3 or 4, characterized thereof that the reagent with an allyl or an epoxy residue is added 1-25 wt % to the lower alkylhydroxy ether substituted polysaccharide for preparing an activatable polysaccharide polymer.
   6. The method according to clause 5, characterized thereof, that the reagent containing an allyl and/or epoxy residue is an allyl glycidyl ether or a glycidyl ether residue, or an allyl halide residue.
   7. The method according to any of the preceding clauses, characterized thereof, that additional crosslinking reagent is an organic moiety containing diacid and/or dihydroxy functionality preferably aldaric acid or its derivative of the formula (II)

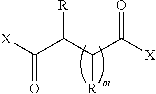

wherein
R represents a substituent selected from the group consisting of hydroxy, hydroxyl or OCO(CH₂)ₙCH₃ or O(CH2)ₙCH₃ and wherein n is a total number from 1 to 14,
X represents a substituent selected from: hydroxyl, lower alkyloxy, aryloxy, halogen, —NHR′ or
NH(CH₂)ₙCH═CH₂ or NH(CH₂)ₙCH(O)CH₂, wherein
R′ represents C₂-C₁₆-hydrocarbyl containing a residue containing terminal unsaturation such as an allyl group, an epoxy residue or an amino residue,
m is a total number from 1 to 3 for preparing a xylan polymer with an additional activatable crosslinker.
8. The method according to clause 7, characterized thereof, that X means hydroxyl group and R is hydroxyl or lower alkoxy.
9. The method according to clause 7 or 8, characterized thereof, that the aldaric acid derivative is allylamide based aldaric acid derivative.
10. The method according to any of the preceding clauses, characterized thereof, that the activatable polysaccharide polymer chain or polysaccharide polymer chain with an additional activatable crosslinker is crosslinked with another activatable polysaccharide polymer chain or polysaccharide polymer chain with an additional activatable crosslinker, by activating dissolved activatable polysaccharide polymer or polysaccharide polymers with an additional activatable crosslinker with an iniator.
11. The method for controlling the opaqueness and pore structure of the hydrogel by preparing the hydrogel according to clause 2 in which the amount of the additional crosslinker in an activatable xylan polymer is varied between 1 to 25 wt-% from total weight of the xylan polymer.
12. The method for controlling the swelling properties of the hydrogel prepared according to clause 2 by varying the substitution degree of ester or ether moiety in pyranose unit(s) by the reagent, which has an allyl and/or epoxy functionality.
13. A film or hydrogel containing polysaccharide polymer backbone, preferably xylan polymer backbone, in which at least one hydroxyl of a pyranose unit is substituted with an ether or ester moiety, characterized thereof, that at least one ether or ester moiety further contains substituent selected from the group containing of an allyl glycidyl ether or a glycidyl ether residue or an allyl halide residue.
14. A film or hydrogel containing xylan polymer backbone in which at least one hydroxyl of a of a pyranose unit is substituted with an ether or ester moiety, characterized thereof, that said ether of ester moiety further contains substituent selected from the group containing of an residue having an ethenyl and/or epoxy functionality and whereby said substituted ether or ether moiety with ethenyl and/or epoxy functionality contains also an additional crosslinking substituent having at least two crosslinking functionality.
15. The film or hydrogel according to clause 14, characterized thereof, that an additional crosslinking substituent with at least two crosslinking functionality is obtained by oxidation of a monosaccharide preferably a monosaccharide obtained from hemicellulose.
16. The film or hydrogel according to clause 15, characterized thereof, that an additional crosslinking substituent is obtained by oxidation of xylose, arabinose, galactose or mannose.
17. The film or hydrogel according to any of the clauses 13-16, characterized thereof, that an additional crosslinking substituent is aldaric acid or its derivative of the formula (II)

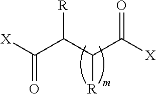

wherein
R represents a substituent selected from the group consisting of hydroxy, hydroxyl or OCO(CH₂)ₙCH₃ or O(CH2)ₙCH₃ and wherein n is a total number from 1 to 14,
X represents a substituent selected from: hydroxyl, lower alkyloxy, aryloxy, halogen, —NHR′ or
NH(CH₂)ₙCH═CH₂ or NH(CH₂)ₙCH(O)CH₂, wherein
R′ represents C₂-C₁₆-hydrocarbyl containing a residue comprising terminal unsaturation such as an allyl group, an epoxy residue or an amino residue,
m is a total number from 1 to 3 for preparing an activated xylan polymer with an additional crosslinker.
18. The film or hydrogel according to clause 17, characterized thereof, that X means hydroxyl group and R is hydroxyl or lower alkoxy.
19. The film or hydrogel according to clause 17 or 18, characterized thereof, that the aldaric acid derivative is allylamide based aldaric acid derivative.
20. The hydrogel according to any of the clauses 13-19, characterized thereof, that opaqueness and pore structure of the hydrogel is modified by varying the amount of the additional crosslinker substituted into ether or ester moiety of the pyranose unit which contains also an residue having an ethenyl and/or epoxy functionality, from 1 to 25 wt-% of total weight of the xylan polymer.
21. The hydrogel according to any of the clauses 13-20, characterized thereof, that the mechanical strength of the hydrogel is modified by varying the substitution degree of an allyl and/or an epoxy functionality to the ester or ether substituted moiety of the pyranose unit(s).
22. The hydrogel according to clause 21, characterized thereof, that the mechanical strength of the hydrogel is increased by increasing the degree of substitution of the allyl functionality to the ester or ether substituted moiety of the pyranose unit(s)
23 The hydrogel according to any of the clauses 13-22, characterized thereof, that the swelling properties of the hydrogel is modified by varying the quality of the additional crosslinker and/or the substitution degree of the additional crosslinker into pyranose unit(s) of the xylan polysaccharide whereby said ether of ester moiety further contains substituent selected from the group containing of an residue having an ethenyl and/or an epoxy functionality.

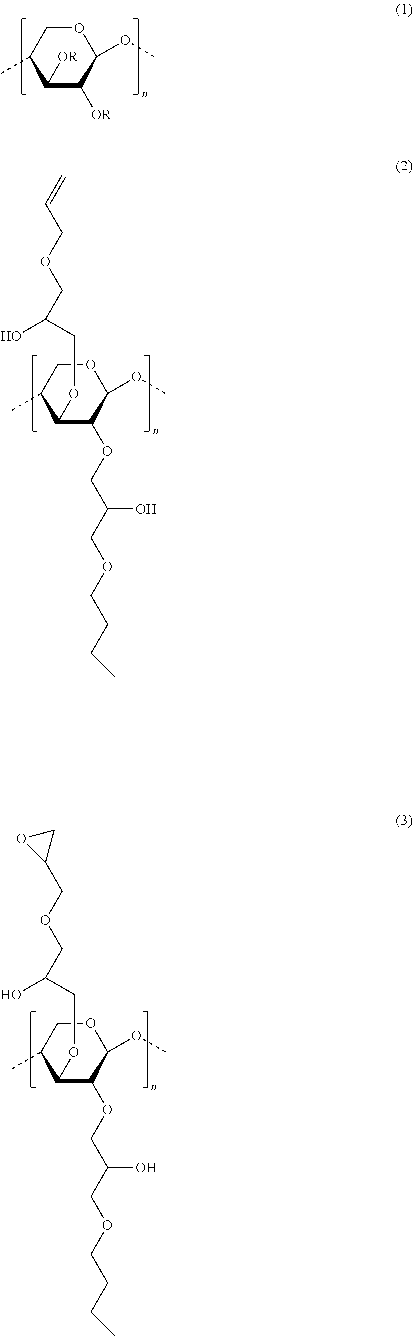

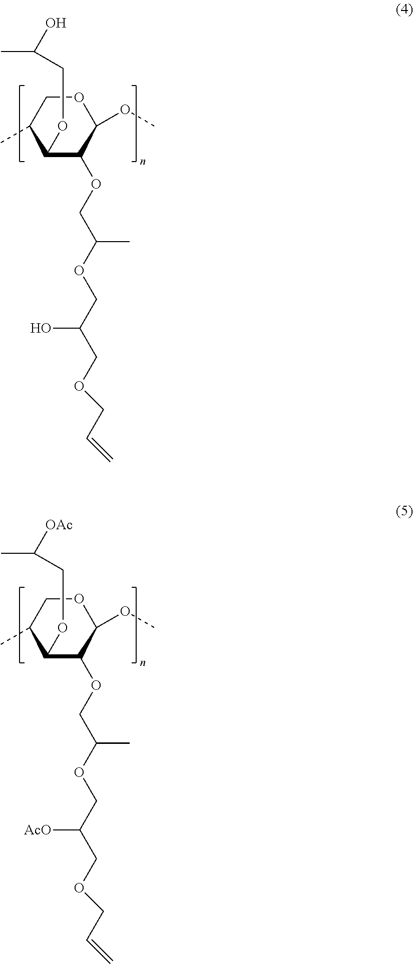

FIG. 1. Some examples of modified birch xylans. (1) anhydroxylopyranosyl unit (AXU), when R═H; (2) a xylan derivative with two different substituents prepared using glycidyl allyl and glycidyl butyl ethers as derivatizing reagents; (3) the allyl group is converted to an epoxy group; (4) AXU is first converted to a hydroxypropyl derivative which is further derivatized with glycidyl allyl ether; (5) new free hydroxyl groups generated in the opening of an epoxy ring can be further blocked as an ester, here with acetyl groups.

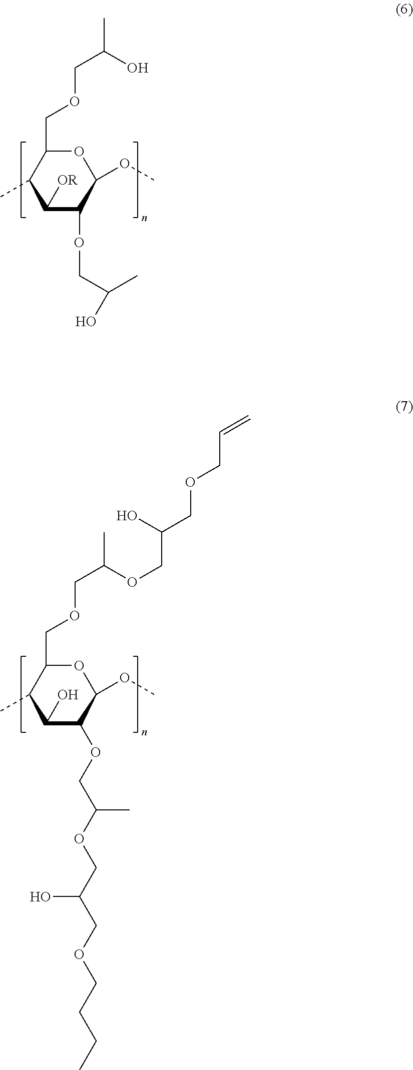

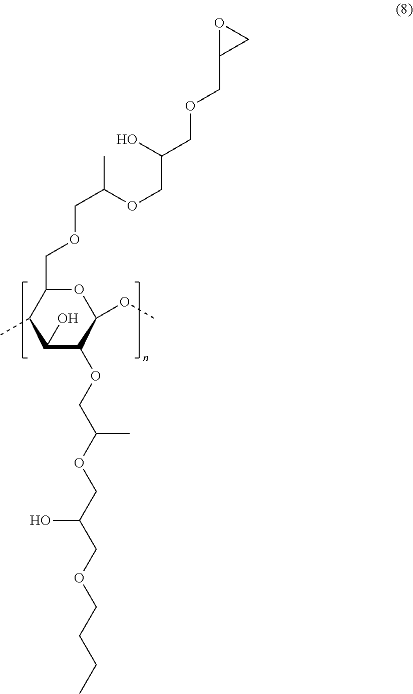

FIG. 2. Some examples of modified celluloses based on commercial celluloses derivatives such as hydroxypropyl celluloses: (6) Hydroxypropyl cellulose (HPC); (7) HPC derivative with butyl and allyl ether groups; and (8) where allylic double bond is converted to an epoxy group.

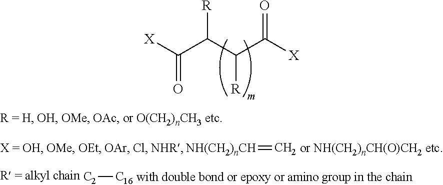

FIG. 3. Aldaric acid derivatives (m=1-3, n=1-14). Most often the R is a free hydroxyl group but also, for instance, hydroxyl groups may be blocked to methyl or acetyl groups. The X in aldaric acids is basically a hydroxyl group but it is often converted to other functionalities such as esters or amides containing also double bonds or epoxy groups for further crosslinking and/or grafting reactions.

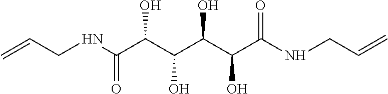 [SMILES: C=CCNC(=O)[C@@H](O)[C@H](O)[C@H](O)[C@@H](O)C(=O)NCC=C]

FIG. 4. One example of N,N′-diallylaldardiamides, galactaric acid derived N,N′-diallylgalactardiamide.

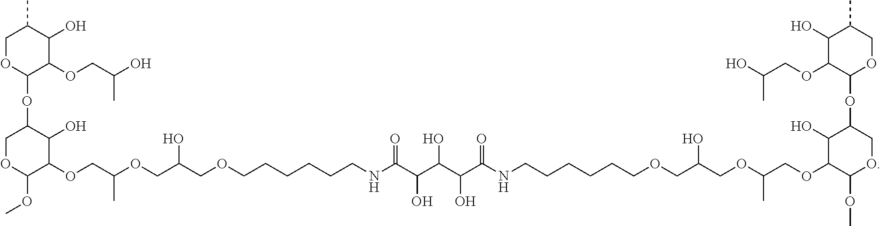 [SMILES: COC1OCC(OC2OC[C@@H](C)C(O)C2OCC(C)O)C(O)C1OCC(C)OCC(O)COCCCCCCNC(=O)C(O)C(O)C(O)C(=O)NCCCCCCOCC(O)COC(C)COC1C(OC)OCC(OC2OC[C@H](C)C(O)C2OCC(C)O)C1O]

FIG. 6. Schematic structure of crosslinked hydroxypropylated and allylated xylan derivative. As a crosslinker N,N′-diallylaldardiamide.

### REFERENCES

Anker, H. S. FEBS Lett., 1970, 7, 293.
Cuggnino, J. C., Igarzabal, C. I. A., Rueda, J. C., Quinzani, L. M., Komber, H., Strumia, M. C., Eur. Polym. J., 2008, 44, 3548-3555.
Glasser, W. G., Jain, R. K., Sjöstedt, M. A., U.S. Pat. No. 5,430,142.
Jain, R. K., Sjöstedt, M., Glasser, W. G., Cellulose, 2001, 7, 319-336.
Lindblad, M. S. Albertsson, A.-C., Ranucci, E., Laus, M., Giani, E., Biomacromol., 2005, 6, 684-690.
Mohan, Y. M., Murthy, P. S. K., Raju, K. M., React. Funct. Polym., 2005, 63, 11-26.
Oh, J. K., Lee, D. I., Park, J. M. Progr. Polym. Sci., 2009, 34, 1261-1282.
Wenz, G., Höfler, T. Synthesis of highly water-soluble cyclodextrin sulfonates by addition of hydrogen sulfite to cyclodextrin allylethers. Carbohydr. Res. 322 (1999) 153-165.
Zhao, S. P., Cao, M. J., Li, L. Y., Xu, W. L., Polym. Degradation Stabil., 2010, 95, 719-724.
ⁱHennink, W. E.; van Nostrum, C. F. Drug Delivery Rev. 2002, 54, 13-36.
ⁱⁱYin, Y.-L.; Prud'homme, R. K.; Stanley, F. Chapter 6. In Polyelectrolyte Gels: Properties, Preparation, and Applications; Harland, R. S.; Prud'homme, R. K. ACS Symposium Series, Washington, D.C., 1992; Vol. 480, pp 91-113.
ⁱⁱⁱLee, K. Y.; Mooney, D. J. Chem. rev. 2001, 101, 1869-1879.
^{iv}Alvarez-Lorenzo, C.; Concheiro, A. Mini-Rev. Med. Chem. 2008, 8, 1065-1074.
^{v}Voepel, J.; Sjöberg, J.; Reif, M.; Albertsson, A.-C.; Hultin, U.-K.; Gasslander, U. J. Appl. Polym. Sci. 2009, 112, 2401-2412.
^{vi}Guilherme, M. R.; Reis, A. V.; Paulino, A. T.; Moia, T. A.; Mattoso, L. H. C.; Tambourgi, E. B. J. Appl. Polym. Sci. 2010, 117, 3146-3154.
^{vii}Wang, W.; Wang, A. Adv. Mater. Res. 2010, 96, 177-182.
^{viii}Seneviratine, C. M. W. PCT Int. App WO2009/036483 A1
^{ix}Voepel, J.; Edlund, U.; Albertsson, A.-C. J. Polym. Sci., Part A: Polym. Chem. 2009, 47, 3595-3606.
^{x}Tanodekaew, S.; Channasanon, S.; Uppanan, P. J. Appl. Polym. Sci. 2006, 100, 1914-1918.
^{xi}Gabrielii, I.; Gatenholm, P. J. Appl. Polym. Sci. 1998, 69, 1661-1667.
^{xii}Lindblad, M.; Ranucci, E.; Albertsson, A.-C. Macromol. Rapid Commun. 2001, 22, 962-967.
^{xiii}Mojzita, D.; Wiebe, M.; Hilditch, S.; Boer, H.; Penttilä, M.; Richard, P. Appl. Environ. Microbiol. 2010, 76, 169-175
^{xiv}Anker, H. S. FEBS Letters, 1970, 7, 293.
^{xv}Tabern, D. L. U.S. Pat. No. 2,084,626, 1937
^{xvi}Henkensmeier, D.; Cajus Abele, B.; Candussio, A.; Thiem, J. J. Polym. Sci., Part A: Polym. Chem. 2005, 43, 3814.
^{xvii}Huijbrechts, A. M. L.; Desse, M.; Budtova, T.; Franssen, M. C. R.; Visser, G. M.; Boeriu, C. G.; Sudhölter, E. J. R. Carbohydr. Polym. 2008, 74, 170-184.
^{xvii}Shen, X.; Kitajyo, Y.; Duan, Q.; Narumi, A.; Kaga, H.; Kaneko, N.; Satoh, T.; Kakuchi, T. Polym. Bull. 2006, 56, 137-143.
^{xix}Kiely, D. E.; Carter, A.; Shrout, D. P. U.S. Pat. No. 5,599,977, 1997
^{xx}Kiely, D. E.; Chen, L.; Lin, T. J. Polym. Sci. 2000, 38, 594-603
^{xxi}Glasser, W. G.; Kaar, W. E.; Jain, R. J.; Sealey, J. E. Cellulose 2000, 7, 299-317
^{xxii}Jin, R. K.; Sjöstedt, M.; Glasser, W. G. Cellulose 2001, 7, 319-336

1. A method for making specific products from polysaccharide molecule(s) containing ether or ester bonded substituents, wherein said method comprises
providing hydroxyl groups of a polysaccharide molecule with numerous of coupling substituents, wherein said coupling substituents are substituted via ether or ester bonds, preferably via ether bonds, to said polysaccharide molecule, wherein said coupling substituents enable crosslinking two polysaccharide polymers with each other or enable coupling a polysaccharide polymer with another polymer or enable grafting of a polymer side chain from same kind or different kind of monomer(s) onto said polysaccharide molecule and
making a selected product from said polysaccharide molecule with numerous coupling substituents by crosslinking said polysaccharide molecule with the same kind of different kind of polysaccharide molecule or forming bonds between said polysaccharide molecule and another kind of polymer molecule or grafting polymer from same kind or different kind or monomer(s) onto said polysaccharide molecule.

2. The method according to claim 1, wherein polysaccharide molecule A is reacted with another polysaccharide molecule B according to general crosslinking reaction (1):
AS₁-(R₁)ₙ+(R₂)ₘ-BS₂->(AS₁-(R₁-R₂)ₙ₊ₘ₋₂ₓ-BS₂) (1)
or polysaccharide molecule A is grafted with a monomer M according to general grafting reaction (3) for forming a polymer side-chain onto said polysaccharide molecule
AC-(R₁)ₙ+xM->AC-(R₁)ₙ₋ₓ-co-poly(M) (3)
or polysaccharide molecule A is coupled with a polymer poly(M) according to general coupling reaction (4):
AC-(R₁)ₙ+xpoly(M)->AC-(R₁)ₙ₋ₓ-co-poly(M) (4),
wherein
A and B means independently from each other same or different kind of polysaccharide molecule and if A and B means the same kind of polysaccharide molecule crosslinking reactions (1) can be performed between same polysaccharide polymer (internal crosslinking),
S₁ and S₂ means independently from each other same or different kind of non-coupling substituents of said polysaccharide molecule A or B,
R₁ and R₂ means independently from each other same or different coupling substituents containing a reactive double bond in a case of radical reaction or related crosslinking, or polymerization reactions; and bonded to said polysaccharide molecule A or B via ether or ester bonding preferably via ether bonding,
otherwise R₁ and R₂ means independently from each other reactive substituents, which may form together a coupling,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
whereby the degree of substitution (DS) of the hydroxyl groups with coupling substituents to the polysaccharide is between 0.01 to about 1
and
x is the number of coupling substituents reacted with each other, additional crosslinking reagents, monomers, or polymers, whereby in reaction (1) x means the number of coupling substituents reacted with each other, in reaction (3) x signifies the number of coupling substituents onto which the monomers of the polymer have been grafted and in reaction (4) x signifies the number of coupling substituents, which have contacted with specific groups of polymer (M).

3. The method according to claim 1, wherein coupling substituents R₁ or R₂ are bonded to polysaccharide polymer via ether bonds and polysaccharide molecules originate to cellulose, lignocellulose or hemicellulose material.

4. The method according to claim 3, wherein cellulose fibers comprise microfibrillated cellulose fibers or regenerated cellulose fibers.

5. The method according to claim 3, wherein hemicellulose comprise xylan polymers.

6. The method according to claim 3 wherein cellulose fibers have been bleached by treating them with base such as NaOH.

7. The method according to claim 3, wherein before providing hydroxyl groups of a polysaccharide molecule with numerous of coupling substituent, the pulp containing polysaccharide molecules is first activated with a bleaching agent and activated and extracted polysaccharide molecules are thereafter reacted with an etherification agent.

8. The method according to claim 1, wherein polysaccharide molecules A and B are crosslinked together using an additional coupling reagent Z according to reaction (2):
AS₁-(R₁)ₙ+BS₂-(R₂)ₘ+xZ->(AS₁-(R₁)ₙ₋ₓ-Zₙ₋ₓ-(R₂)ₘ₋ₓ-BS₂) (2),
wherein
A and B means independently from each other the same or different kind of polysaccharide molecule and if A and B means the same kind of polysaccharide molecule crosslinking reactions (1) can be performed between same coupling substituents of the same polysaccharide polymer (intramolecular 1 crosslinking),
R₁ and R₂ means independently from each other same or different coupling substituents containing a reactive double bond in a case of radical reaction or related crosslinking, or polymerization reactions; and bonded to said polysaccharide molecule A or B via ether or ester bonding preferably via ether bonding,
otherwise R₁ and R₂ means independently from each other reactive substituents, which may form together a coupling,
Z is an additional coupling reagent forming an additional coupling agent between R₁ and R₂ whereby Z contains at least on double bond in case of radical reactions, otherwise Z is an additional coupling reagent used in polysaccharide chemistry which contains at least two groups, which can be reacted with R₁ and/or R₂,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
x signifies in reaction (2) x the number of coupling substituents reacted with additional coupling agents,
whereby the degree of substitution (DS) of the hydroxyl groups with coupling substituents of the polysaccharide is between 0.01 to about 1

9. The method according to claim 1, wherein R₁ or R₂ is a substituent, which is substituted to the hydroxyl group of the saccharide unit and bonded to said polysaccharide molecule via —O— or —O—CO— bond, preferably via ether bond and wherein said R₁ or R₂ denotes an aliphatic, aromatic, heteroaromatic or heterocyclic residue comprising at least one of the following functionalities: unsaturated group, acrylic, acrylamide, allyl, amino, carbonyl, epoxy, hydroxyl, isocyanate or vinyl.

10. The method according to claim 9, wherein R₁ or R₂ is selected from the group comprising: alkenyls having unsaturated terminal group such as allyl or vinyl, epoxides including glycidyls and glycidyl ethers such as lower alkyl glycidyl ethers and lower alkenyl glycidyl ethers, monoepoxides such as lower alkylene ethers including ethylene oxide, propylene oxide and 1,2-epoxybutane and 1,2-epoxyhexane, acrylates such as metacrylate or acrylamides such as methyleneacrylamide.

11. The method according to claim 8, wherein additional coupling reagent Z is an organic moiety containing at least two functionalities, which enables the reagent Z to be reacted with R₁ or/and R₂ for making coupling(s) with the same.

12. The method according to claim 11, wherein Z is a reagent, which can be bonded with a covalent bond with R₁ or/and R₂, wherein Z denotes aliphatic, aromatic, heteroaromatic or heterocyclic residue comprising at least two coupling functionalities selected from the group comprising: unsaturated group, acrylic, acrylamide, allyl, amino, carbonyl, epoxy, hydroxyl, isocyanate or vinyl.

13. The method according to claim 12, wherein coupling substituent R₁ or R₂ comprises substituents having unsaturated terminal group such as allyl or vinyl group or an epoxide and additional coupling reagent, is a compound having at least two coupling functionality selected from the group consisting of diepoxy compounds or diacid compounds such as carbohydrate acids.

14. The method according to claim 12, wherein additional coupling reagent Z is an organic moiety containing diacid and/or dihydroxy functionality, preferably carbohydrate diacid such as aldaric acid or its derivative of the general formula (II) 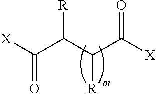
wherein
R represents a substituent selected from the group consisting of hydroxy, hydroxyl or OCO(CH₂)ₙCH₃ or O(CH2)ₙCH₃ and wherein n is a total number from 1 to 14,
X represents a substituent selected from: hydroxyl, lower alkyloxy, aryloxy, halogen, —NHR′ or
NH(CH₂)ₙCH═CH₂ or NH(CH₂)ₙCH(O)CH₂, wherein
R′ represents C₂-C₁₆-hydrocarbyl containing a residue comprising terminal unsaturation such as an allyl group, an epoxy residue or an amino residue,
m is a total number from 1 to 3.

15. The method according to claim 13, wherein X means hydroxyl group and R is hydroxyl or lower alkoxy.

16. The method according to claim 14, wherein aldaric acid derivative is allylamide based aldaric acid derivative.

17. The method according to claim 11, for preparing hydrogels, films or membranes.

18. The method according to claim 17 for preparing hydrogels, wherein hydrogel is prepared from polysaccharide comprising hemicellulose polymers such as xylan polymers.

19. The method according to claim 18 for preparing hydrogels, wherein the opaqueness and pore structure of the hydrogel is modified by varying the amount of the additional coupling agent substituted into ether or ester moiety of the pyranose or hexose unit of the xylan polymer, which coupling substituent or agent contains also an residue having an ethenyl and/or epoxy functionality, from 1 to 25 wt-% of total weight of the xylan polymer.

20. The method according to claim 18 for preparing hydrogels, wherein the mechanical strength of the hydrogel is modified by varying the substitution degree of an allyl and/or an epoxy functionality to the ester or ether substituted moiety of the pyranose unit(s).

21. The method according to claim 20 for preparing hydrogels wherein the mechanical strength of the hydrogel is increased by increasing the degree of substitution of the allyl functionality to the ester or ether substituted moiety of the pyranose unit(s).

22. The method according to claim 18 for preparing hydrogels, wherein the swelling properties of the hydrogel is modified by varying the quality of the additional coupling reagent and/or the substitution degree of the additional coupling reagent whereby said ether of ester moiety further contains substituent selected from the group containing of an residue having a terminal unsaturation such as allyl functionality and/or an epoxy functionality.

23. The method according to claim 1 for preparing a membrane, hydrogel, film or fiber composite, wherein the method comprises at least one of the following stages:
(a1) crosslinking cellulose or hemicellulose polymer (A) provided with numerous coupling substituents with a second cellulose or hemicellulose polymer (B) provided with numerous coupling substituents by activating possibly dissolved cellulose or hemicellulose polymer with a reaction iniator such as photoiniator, whereby the reaction is performed according to general reaction (1)
AS₁-(R₁)ₙ+(R₂)ₘ-BS₂->(AS₁-(R₁-R₂)ₙ₊ₘ₋₂ₓ-BS₂) (1)
or
(a2) crosslinking polysaccharide molecules A and B together using an additional coupling reagent Z according to general reaction (2):
AS₁-(R₁)ₙ+BS₂-(R₂)ₘ+xZ->(AS₁-(R₁)ₙ₋ₓ-Zₙ₋ₓ-(R₂)ₘ₋ₓ-BS₂) (2)
and
possibly the cellulose or hemicellulose molecule A or B provided with numerous coupling substituents can also undergo reactions (3) or (4) of corresponding reaction steps b1 or b2 before, after or simultaneously of reaction steps a1 and a2 (in reactions (3) and (4) is shown reaction only to molecule A, molecule B is modified accordingly):
(b1) reacting cellulose or hemicellulose polymer (A or B) provided with numerous coupling substituents with monomers (M) according to general reaction (3)
AC-(R₁)ₙ+xM->AC-(R₁)ₙ₋ₓ-co-poly(M) (3)
and/or
(b2) coupling said cellulose or hemicellulose polymer (A or B) with polymer poly(M) made of monomers M according to general reaction (4):
AC-(R₁)ₙ+poly(M)->AC-(R₁)^{n-x}-co-poly(M) (4)
wherein
A and B means independently from each other the same or different kind of polysaccharide molecule and if A and B means the same kind of polysaccharide molecule crosslinking reactions (1) can be performed between same polysaccharide polymer (internal crosslinking),
S₁ and S₂ means independently from each other same or different kind of non-coupling substituents of said polysaccharide molecule A or B,
R₁ and R₂ means independently from each other the same or different coupling substituents containing a reactive double bond in a case of radical reaction or related crosslinking or polymerization reactions and bonded to said polysaccharide molecule A or B via ether or ester bonding preferably via ether bonding,
otherwise R₁ and R₂ means independently from each other reactive substituents, which may form together a coupling,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
whereby the degree of substitution (DS) of the hydroxyl groups with coupling substituents to the polysaccharide is between 0.01 to about 1 and
x is the number of reacted coupling substituents whereby in reaction (1) x means the number of coupling substituents reacted with each other, in reaction (2) x signifies the number of coupling substituents reacted with additional coupling agents, in reaction (3) x signifies the number of coupling substituents onto which the monomers of the polymer have been grafted and in reaction (4) x signifies the number of coupling substituents.

24. The method according to claim 1 for preparing membrane, hydrogel, coating, primer, binding agent, film or composite said method comprising at least the following stages:
(c) attaching cellulose or hemicellulose molecules provided with numerous coupling substituents, onto a material substrate whereby possibly coupling reaction between said substrate and said coupling substituents is done according to reaction scheme (4)
AC-(R₁)ₙ+xpoly(M)->AC-(R₁)ₙ₋ₓ-co-poly(M) (4)
and
(d) crosslinking said cellulose or hemicellulose polymer chains (A) and (B) with each other according to reaction scheme (1)
AS₁-(R₁)ₙ+(R₂)ₘ-BS₂->(AS₁-(R₁-R₂)ₙ₊ₘ₋₂ₓ-BS₂) (1)
or/and
e) grafting said cellulose or hemicellulose polymer chains (A) and (B) with a monomer M according to general reaction scheme (3):
AC-(R₁)ₙ+xM->AC-(R₁)ₙ₋ₓ-co-poly(M) (3)
wherein
A and B means independently from each other the same or different kind of polysaccharide molecule and if A and B means the same kind of polysaccharide molecule crosslinking reactions (1) can be performed between same coupling substituents of the same polysaccharide polymer (internal crosslinking),
R₁ and R₂ means independently from each other same or different coupling substituents containing a reactive double bond in a case of radical reaction and bonded to said polysaccharide molecule A or B via ether or ester bonding preferably via ether bonding,
otherwise R₁ and R₂ means independently from each other reactive substituents, which may form together a coupling,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
x means in reaction (1) the number of coupling substituents reacted with each other, in reaction (3) x signifies the number of coupling substituents onto which the monomers of the polymer have been grafted and in reaction (4) x signifies the number of coupling substituents, which have contacted with specific groups of polymer (M),
whereby the degree of substitution (DS) of the hydroxyl groups with coupling substituents of the polysaccharide is between 0.01 to about 1.

25. The method according to claim 24 for preparing coating, primer or film for coating applications wherein cellulose or hemicellulose molecules, which are provided with numerous coupling substituents undergo at least one of the following stages:
c) attaching cellulose or hemicellulose molecules provided with numerous coupling substituents, onto a substrate by possibly coupling said matrix with coupling substituents according to reaction scheme (4):
AC-(R₁)ₙ+xpoly(M)->AC-(R₁)ₙ₋ₓ-co-poly(M) (4)
and/or
e) grafting said cellulose or hemicellulose polymer chains (A) and (B) with a monomer M according to general reaction scheme (3):
AC-(R₁)ₙ+xM->AC-(R₁)ₙ₋ₓ-co-poly(M) (3)
wherein
A and B means independently from each other the same or different kind of polysaccharide molecule and if A and B means the same kind of polysaccharide molecule crosslinking reactions (1) can be performed between
same coupling substituents of the same polysaccharide polymer (internal crosslinking),
R₁ and R₂ means independently from each other same or different coupling substituents containing a reactive double bond in a case of radical reaction and bonded to said polysaccharide molecule A or B via ether or ester bonding preferably via ether bonding,
otherwise R₁ and R₂ means independently from each other reactive substituents, which may form together a coupling,
M is a monomer containing at least one double bond in a case of a radical reaction or a substituent enabling grafting monomer(s) on R₁ or R₂,
Poly(M) is a polymer made of monomer(s) M by polymerization and
n and m is the number of (coupling) substituents in one polysaccharide molecule, n or m is between 5 to 1000, preferably in the range of 10-100,
x is the number of coupling substituents reacted whereby in reaction (3) x signifies the number of coupling substituents onto which the monomers of the polymer have been grafted and in reaction (4) x signifies the number of coupling substituents, which have contacted with specific groups of polymer (M),
whereby the degree of substitution (DS) of the hydroxyl groups with coupling substituents of the polysaccharide is between 0.01 to about 1.

26. The method according to claim 25, wherein polymer contains stimuli-responsive groups.

27. The method according to claim 26 wherein grafted polymer is polyvinyl alcohol.

28. The method according to claim 25, wherein cellulose or hemicellulose molecules provided with numerous coupling substituents are attached onto a matrix material without using said coupling substituents for said attaching reaction.

29. The method according to claim 25, wherein cellulose or hemicellulose molecules provided with numerous coupling substituents are attached onto a polymer matrix material using said coupling substituents for said attaching reaction.

30. The method according to 28 for modifying surface properties of said polymer matrix material, such as hydrophobicity-hydrofilicity balance.

31. The method according to claim 25, wherein on the cellulose or hemicellulose molecule is grafted a copolymer side-chain.

32. The method according claim 31 for grafting polymer layers onto fibrous, non-woven, or membrane type matrix material such as polypropene (PP), polyethylene (PE), polyvinyl alcohol (PVA), polyethylene terephthalates (PET), or cellulose fibre based media by attaching cellulose or hemicellulose molecules provided with coupling substituents, onto said material matrix and thereafter grafting on said cellulose or hemicellulose polymer chains (A) and (B) polymer composing of monomers M

33. The method according to claim 24 any of, wherein the material substate such as filter fabrics is preactivated using corona, plasma, chemical treatments or UV radiation.

34. The method according to claim 1, wherein polysaccharide molecule contain also other reactive groups, which do not take part of coupling, crosslinking or grafting reactions defined previously, whereby said substituent have an adjusted degree of substitution (DS) into said polysaccharide molecule for adjusting absorptivity, solubility, polarity, mechanical strength, hydrophobic-hydrophilic balance of the final product.

35. The method according to claim 2, wherein cellulose or hemicellulose molecules (A) and (B) are crosslinked with each other and/or wherein onto said cellulose or hemicellulose molecule is grafted a polymer denoted as polymer poly-(M) comprising monomers (M).
